(19) United States
(12) Patent Application Publication
(10) Pub. No.: US 2024/0054387 A1
(43) Pub. Date: Feb. 15, 2024

(54) GRADIENT COMMUNICATION FOR MODEL UPDATING

(71) Applicant: QUALCOMM Incorporated, San Diego, CA (US)

(72) Inventors: Tianyang BAI, Somerville, NJ (US); Hua WANG, Basking Ridge, NJ (US); Junyi LI, Fairless Hills, PA (US)

(21) Appl. No.: 17/819,216

(22) Filed: Aug. 11, 2022

(51) Int. Cl. G06N 20/00; H04W 72/12

(52) U.S. Cl. CPC G06N 20/00; H04W 72/121; H04W 72/1289

(57) ABSTRACT

Various aspects of the present disclosure generally relate to wireless communication. In some aspects, a reporting user equipment (UE) may receive feedback that indicates a plurality of local gradients from a plurality of respective transmitter UEs via a first plurality of respective resources. The UE may generate a combined gradient based at least in part on a median of the plurality of local gradients or a trimmed average of the plurality of local gradients. The UE may transmit the combined gradient to a network node via a second resource that is shared by the reporting UE and at least one other reporting UE configured to transmit a respective combined gradient to the network node. Numerous other aspects are provided.

### FIELD OF THE DISCLOSURE

Aspects of the present disclosure generally relate to wireless communication and specifically, to techniques and apparatuses for gradient communication for model updating.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Tenn Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some cases, a user equipment (UE) may transmit a sidelink communication that includes an arbitrary gradient or an adversarial gradient associated with a model (for example, a federated learning model). A gradient may be a derivative that is determined based at least in part on applying local data (for example, data associated with the UE) to the model. An arbitrary gradient may be a gradient that is incorrectly determined by the UE, such as a gradient that is calculated based at least in part on an incorrect dataset. An adversarial gradient may be a gradient that is intended to corrupt the model. The arbitrary gradient or the adversarial gradient may cause the model to become corrupted or to suffer from performance loss. For example, a network node may incorrectly calculate a global gradient (that is used for model updating) based at least in part on the arbitrary gradient or the adversarial gradient. In some cases, the network node may be able to detect whether the gradient is trustworthy when the gradient is received from the UE using digital feedback. Gradients received from the UE may be removed from future averaging of gradients, or the UE may be required to provide further authentication, based at least in part on the network node determining that one or more gradients received from the UE are arbitrary gradients or adversarial gradients. However, when analog feedback is used (for example, during sidelink communications), the network node may only receive the aggregated sum of the gradients, and may not be able to identify the individual gradients from each of the respective UEs. Thus, the network node may not be able to determine whether the feedback includes an arbitrary gradient or an adversarial gradient, and may not be able to identify which of the UEs sent the arbitrary gradient or the adversarial gradient. This may increase the likelihood that the model becomes corrupted.

### SUMMARY

Some aspects described herein relate to a method of wireless communication performed by a reporting user equipment (UE). The method may include receiving feedback that indicates a plurality of local gradients from a plurality of respective transmitter UEs via a first plurality of respective resources. The method may include generating a combined gradient based at least in part on a median of the plurality of local gradients or a trimmed average of the plurality of local gradients. The method may include transmitting the combined gradient to a network node via a second resource that is shared by the reporting UE and at least one other reporting UE configured to transmit a respective combined gradient to the network node.

Some aspects described herein relate to a method of wireless communication performed by a reporting UE. The method may include receiving feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource. The method may include transmitting the aggregate gradient to a network node via a second resource, of a plurality of second resources, that is configured for communicating the aggregate gradient between the reporting UE and the network node, where each second resource of the plurality of second resources is configured for communicating an aggregate gradient between a respective reporting UE and the network node.

Some aspects described herein relate to a method of wireless communication performed by a network node. The method may include transmitting, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs. The method may include receiving a plurality of combined gradients from the plurality of reporting UEs based on the one or more parameters, wherein the plurality of combined gradients are received via a second resource that is shared by the plurality of reporting UEs. The method may include updating a model based at least in part on the plurality of combined gradients.

Some aspects described herein relate to a method of wireless communication performed by a network node. The method may include transmitting, to a plurality of reporting UEs, configuration information that indicates a plurality of resources, wherein each resource of the plurality of resources is configured for a respective reporting UE of the plurality of reporting UEs for communicating an aggregate gradient to the network node. The method may include receiving one or more aggregate gradients, wherein each aggregate gradient of the one or more aggregate gradients is received from a respective reporting UE of the plurality of reporting UEs via a respective resource of the plurality of resources that is configured for the respective reporting UE. The method may include generating a combined gradient based at least in part on a median of the one or more aggregate gradients or a trimmed average of the one or more aggregate gradients. The method may include updating a model based at least in part on the combined gradient.

Some aspects described herein relate to a reporting UE for wireless communication. The reporting UE may include at least one processor and at least one memory, communicatively coupled with the at least one processor, that stores processor-readable code. The processor-readable code, when executed by the at least one processor, may be configured to cause the reporting UE to receive feedback that indicates a plurality of local gradients from a plurality of respective transmitter UEs via a first plurality of respective resources. The processor-readable code, when executed by the at least one processor, may be configured to cause the reporting UE to generate a combined gradient based at least in part on a median of the plurality of local gradients or a trimmed average of the plurality of local gradients. The processor-readable code, when executed by the at least one processor, may be configured to cause the reporting UE to transmit the combined gradient to a network node via a second resource that is shared by the reporting UE and at least one other reporting UE configured to transmit a respective combined gradient to the network node.

Some aspects described herein relate to a reporting UE for wireless communication. The reporting UE may include at least one processor and at least one memory, communicatively coupled with the at least one processor, that stores processor-readable code. The processor-readable code, when executed by the at least one processor, may be configured to cause the reporting UE to receive feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource. The processor-readable code, when executed by the at least one processor, may be configured to cause the reporting UE to transmit the aggregate gradient to a network node via a second resource, of a plurality of second resources, that is configured for communicating the aggregate gradient between the reporting UE and the network node, where each second resource of the plurality of second resources is configured for communicating an aggregate gradient between a respective reporting UE and the network node.

Some aspects described herein relate to a network node for wireless communication. The network node may include at least one processor and at least one memory, communicatively coupled with the at least one processor, that stores processor-readable code. The processor-readable code, when executed by the at least one processor, may be configured to cause the network node to transmit, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs. The processor-readable code, when executed by the at least one processor, may be configured to cause the network node to receive a plurality of combined gradients from the plurality of reporting UEs based on the one or more parameters, wherein the plurality of combined gradients are received via a second resource that is shared by the plurality of reporting UEs. The processor-readable code, when executed by the at least one processor, may be configured to cause the network node to update a model based at least in part on the plurality of combined gradients.

Some aspects described herein relate to a network node for wireless communication. The network node may include at least one processor and at least one memory, communicatively coupled with the at least one processor, that stores processor-readable code. The processor-readable code, when executed by the at least one processor, may be configured to cause the network node to transmit, to a plurality of reporting UEs, configuration information that indicates a plurality of resources, wherein each resource of the plurality of resources is configured for a respective reporting UE of the plurality of reporting UEs for communicating an aggregate gradient to the network node. The processor-readable code, when executed by the at least one processor, may be configured to cause the network node to receive one or more aggregate gradients, wherein each aggregate gradient of the one or more aggregate gradients is received from a respective reporting UE of the plurality of reporting UEs via a respective resource of the plurality of resources that is configured for the respective reporting UE. The processor-readable code, when executed by the at least one processor, may be configured to cause the network node to generate a combined gradient based at least in part on a median of the one or more aggregate gradients or a trimmed average of the one or more aggregate gradients. The processor-readable code, when executed by the at least one processor, may be configured to cause the network node to update a model based at least in part on the combined gradient.

Some aspects described herein relate to a non-transitory computer-readable medium that stores a set of instructions for wireless communication by a reporting UE. The set of instructions, when executed by one or more processors of the reporting UE, may cause the reporting UE to receive feedback that indicates a plurality of local gradients from a plurality of respective transmitter UEs via a first plurality of respective resources. The set of instructions, when executed by one or more processors of the reporting UE, may cause the reporting UE to generate a combined gradient based at least in part on a median of the plurality of local gradients or a trimmed average of the plurality of local gradients. The set of instructions, when executed by one or more processors of the reporting UE, may cause the reporting UE to transmit the combined gradient to a network node via a second resource that is shared by the reporting UE and at least one other reporting UE configured to transmit a respective combined gradient to the network node.

Some aspects described herein relate to a non-transitory computer-readable medium that stores a set of instructions for wireless communication by a reporting UE. The set of instructions, when executed by one or more processors of the reporting UE, may cause the reporting UE to receive feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource. The set of instructions, when executed by one or more processors of the reporting UE, may cause the reporting UE to transmit the aggregate gradient to a network node via a second resource, of a plurality of second resources, that is configured for communicating the aggregate gradient between the reporting UE and the network node, where each second resource of the plurality of second resources is configured for communicating an aggregate gradient between a respective reporting UE and the network node.

Some aspects described herein relate to a non-transitory computer-readable medium that stores a set of instructions for wireless communication by a network node. The set of instructions, when executed by one or more processors of the network node, may cause the network node to transmit, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs. The set of instructions, when executed by one or more processors of the network node, may cause the network node to receive a plurality of combined gradients from the plurality of reporting UEs based on the one or more parameters, wherein the plurality of combined gradients are received via a second resource that is shared by the plurality of reporting UEs. The set of instructions, when executed by one or more processors of the network node, may cause the network node to update a model based at least in part on the plurality of combined gradients.

Some aspects described herein relate to a non-transitory computer-readable medium that stores a set of instructions for wireless communication by a network node. The set of instructions, when executed by one or more processors of the network node, may cause the network node to transmit, to a plurality of reporting UEs, configuration information that indicates a plurality of resources, wherein each resource of the plurality of resources is configured for a respective reporting UE of the plurality of reporting UEs for communicating an aggregate gradient to the network node. The set of instructions, when executed by one or more processors of the network node, may cause the network node to receive one or more aggregate gradients, wherein each aggregate gradient of the one or more aggregate gradients is received from a respective reporting UE of the plurality of reporting UEs via a respective resource of the plurality of resources that is configured for the respective reporting UE. The set of instructions, when executed by one or more processors of the network node, may cause the network node to generate a combined gradient based at least in part on a median of the one or more aggregate gradients or a trimmed average of the one or more aggregate gradients. The set of instructions, when executed by one or more processors of the network node, may cause the network node to update a model based at least in part on the combined gradient.

Some aspects described herein relate to an apparatus for wireless communication. The apparatus may include means for receiving feedback that indicates a plurality of local gradients from a plurality of respective transmitter UEs via a first plurality of respective resources. The apparatus may include means for generating a combined gradient based at least in part on a median of the plurality of local gradients or a trimmed average of the plurality of local gradients. The apparatus may include means for transmitting the combined gradient to a network node via a second resource that is shared by the apparatus and at least one reporting UE configured to transmit a respective combined gradient to the network node.

Some aspects described herein relate to an apparatus for wireless communication. The apparatus may include means for receiving feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource. The apparatus may include means for transmitting the aggregate gradient to a network node via a second resource, of a plurality of second resources, that is configured for communicating the aggregate gradient between the apparatus and the network node, where each second resource of the plurality of second resources is configured for communicating an aggregate gradient between a respective reporting UE and the network node.

Some aspects described herein relate to an apparatus for wireless communication. The apparatus may include means for transmitting, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs. The apparatus may include means for receiving a plurality of combined gradients from the plurality of reporting UEs based on the one or more parameters, wherein the plurality of combined gradients are received via a second resource that is shared by the plurality of reporting UEs. The apparatus may include means for updating a model based at least in part on the plurality of combined gradients.

Some aspects described herein relate to an apparatus for wireless communication. The apparatus may include means for transmitting, to a plurality of reporting UEs, configuration information that indicates a plurality of resources, wherein each resource of the plurality of resources is configured for a respective reporting UE of the plurality of reporting UEs for communicating an aggregate gradient to the apparatus. The apparatus may include means for receiving one or more aggregate gradients, wherein each aggregate gradient of the one or more aggregate gradients is received from a respective reporting UE of the plurality of reporting UEs via a respective resource of the plurality of resources that is configured for the respective reporting UE. The apparatus may include means for generating a combined gradient based at least in part on a median of the one or more aggregate gradients or a trimmed average of the one or more aggregate gradients. The apparatus may include means for updating a model based at least in part on the combined gradient.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of sidelink communications in accordance with the present disclosure.

FIG. 5 is a diagram illustrating an example of sidelink communications and access link communications in accordance with the present disclosure.

FIG. 6 is a diagram illustrating an example model in accordance with the present disclosure.

FIG. 7 is a diagram illustrating an example of gradient feedback in accordance with the present disclosure.

FIG. 8 is a diagram illustrating an example of gradient feedback in accordance with the present disclosure.

FIG. 9 is a diagram illustrating an example of gradient communication for model updating in accordance with the present disclosure.

FIG. 10 is a diagram illustrating an example of gradient communication for model updating in accordance with the present disclosure.

FIG. 11 is a flowchart illustrating an example process performed, for example, by a reporting UE that supports gradient communication for model updating in accordance with the present disclosure.

FIG. 12 is a flowchart illustrating an example process performed, for example, by a UE that supports gradient communication for model updating in accordance with the present disclosure.

FIG. 13 is a flowchart illustrating an example process performed, for example, by a network node that supports gradient communication for model updating in accordance with the present disclosure.

FIG. 14 is a flowchart illustrating an example process performed, for example, by a network node that supports gradient communication for model updating in accordance with the present disclosure.

FIG. 15 is a diagram of an example apparatus for wireless communication that supports gradient communication for model updating in accordance with the present disclosure.

FIG. 16 is a diagram of an example apparatus for wireless communication that supports gradient communication for model updating in accordance with the present disclosure.

FIG. 17 is a diagram of an example apparatus for wireless communication that supports gradient communication for model updating in accordance with the present disclosure.

FIG. 18 is a diagram of an example apparatus for wireless communication that supports gradient communication for model updating in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to gradient communication for model updating. Some aspects more specifically relate to communicating gradient information associated with a federated learning model using a combination of digital feedback and analog feedback techniques. Transmitting the gradient information using digital feedback may enable detection of an arbitrary gradient or an adversarial gradient, but may require more network resources than transmitting the gradient using analog feedback. In contrast, transmitting the gradient information using analog feedback may require fewer network resources based at least in part on an aggregation of the gradients, but may not enable detection of whether a gradient is an arbitrary gradient or an adversarial gradient. In some examples, a reporting user equipment (UE) (for example, a UE that is configured to report a gradient on behalf of one or more other UEs) may receive digital feedback from each of a plurality of transmitter UEs that includes a respective local gradient associated with the transmitter UE. The digital feedback from each transmitter UE may be received via a respective sidelink communication between the reporting UE and the transmitter UE. The reporting UE may remove arbitrary gradients or adversarial gradients from the digital feedback received from the plurality of transmitter UEs. The reporting UE may then generate a combined gradient based at least in part on a median of the local gradients or a trimmed average of the local gradients, and may then transmit the combined gradient to the network node in the form of analog feedback. In some examples, the network node may receive a plurality of combined gradients from a plurality of respective reporting UEs in the form of analog feedback, and may aggerate the plurality of combined gradients. The network node may update the model based at least in part on the combined gradient received from the reporting UE or the plurality of combined gradients received from the plurality of respective reporting UEs.

In some other examples, a reporting UE may receive an aggregate gradient in the form of analog feedback aggregated from analog feedback transmitted by a plurality of transmitter UEs, where the analog feedback from each transmitter UE indicates a local gradient associated with the transmitter UE. The reporting UE may then transmit an indication of the aggregate gradient to the network node in the form of digital feedback. In some such examples, the network node may receive a plurality of aggregate gradients from a plurality of respective reporting UEs using respective digital feedback resources. The network node may generate a combined gradient based at least in part on computing a median or a trimmed average of the plurality of aggregate gradients, and may update the model based at least in part on the combined gradient.

Particular aspects of the subject matter described in this disclosure can be implemented to realize one or more of the following potential advantages. In some examples, the described techniques can be used to improve updating of a federated learning model for sidelink communications. In some examples, the network node may be configured to remove arbitrary gradients and adversarial gradients from digital feedback that is received from one or more reporting UEs. In some other examples, the one or more reporting UEs may be configured to remove arbitrary gradients and adversarial gradients from digital feedback that is received from one or more transmitter UEs, and may be configured to transmit an aggregate gradient to the network node in the form of analog feedback that does not include the arbitrary gradients or the adversarial gradients. By ensuring that at least one of the network node or the reporting UE is able to remove arbitrary gradients and adversarial gradients from the digital feedback, the likelihood of the model becoming corrupted may be decreased.

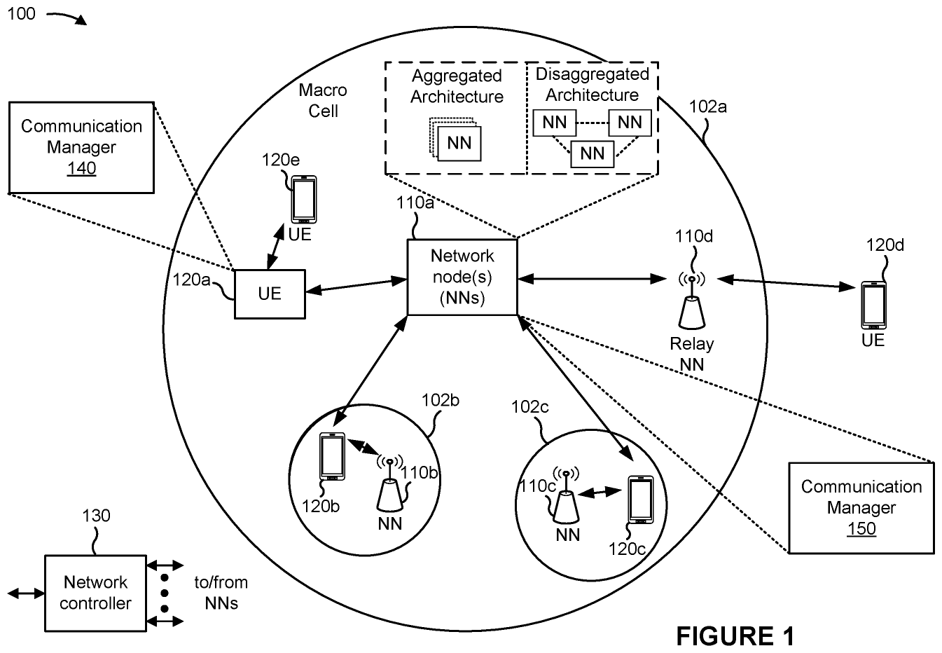

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive feedback that indicates a plurality of local gradients from a plurality of respective transmitter UEs via a first plurality of respective resources; generate a combined gradient based at least in part on a median of the plurality of local gradients or a trimmed average of the plurality of local gradients; and transmit the combined gradient to a network node via a second resource that is shared by the reporting UE and at least one other reporting UE configured to transmit a respective combined gradient to the network node. Additionally or alternatively, the communication manager 140 may perform one or more other operations described herein.

In some aspects, the communication manager 140 may receive feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource; and transmit the aggregate gradient to a network node via a second resource, of a plurality of second resources, that is configured for communicating the aggregate gradient between the reporting UE and the network node, where each second resource of the plurality of second resources is configured for communicating an aggregate gradient between a respective reporting UE and the network node. Additionally or alternatively, the communication manager 140 may perform one or more other operations described herein.

In some aspects, the network node 110 may include a communication manager 150. As described in more detail elsewhere herein, the communication manager 150 may transmit, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs; receive a plurality of combined gradients from the plurality of reporting UEs based on the one or more parameters, wherein the plurality of combined gradients are received via a second resource that is shared by the plurality of reporting UEs; and update a model based at least in part on the plurality of combined gradients. Additionally or alternatively, the communication manager 150 may perform one or more other operations described herein.

In some aspects, the communication manager 150 may transmit, to a plurality of reporting UEs, configuration information that indicates a plurality of resources, wherein each resource of the plurality of resources is configured for a respective reporting UE of the plurality of reporting UEs for communicating an aggregate gradient to the network node; receive one or more aggregate gradients, wherein each aggregate gradient of the one or more aggregate gradients is received from a respective reporting UE of the plurality of reporting UEs via a respective resource of the plurality of resources that is configured for the respective reporting UE; generate a combined gradient based at least in part on a median of the one or more aggregate gradients or a trimmed average of the one or more aggregate gradients; and update a model based at least in part on the combined gradient. Additionally or alternatively, the communication manager 150 may perform one or more other operations described herein.

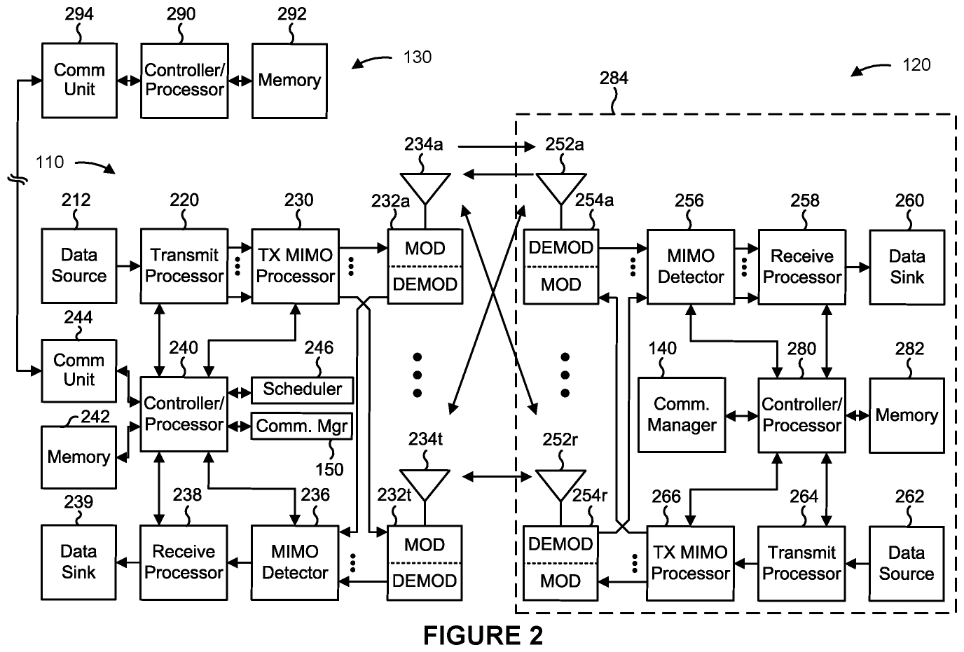

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

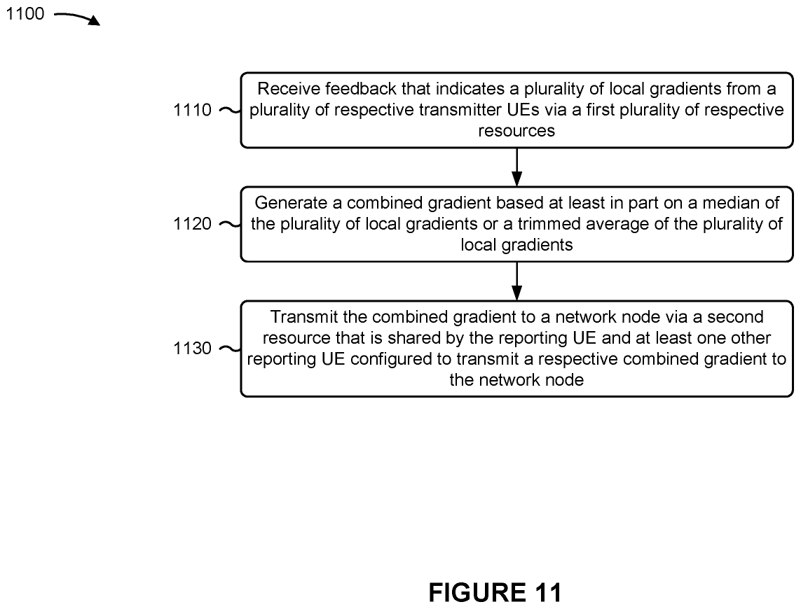

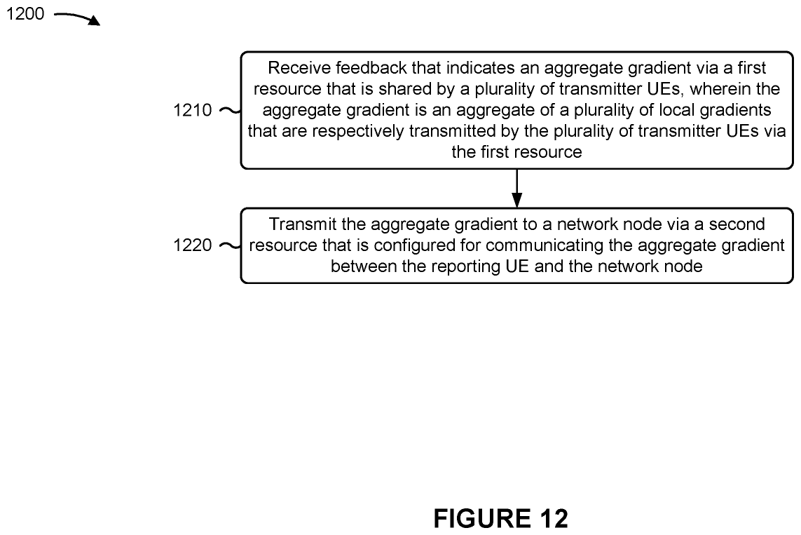

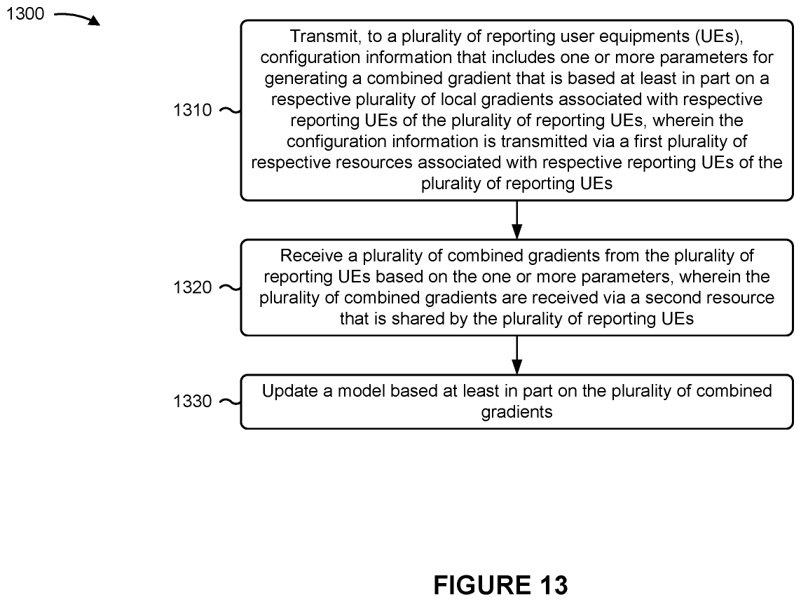

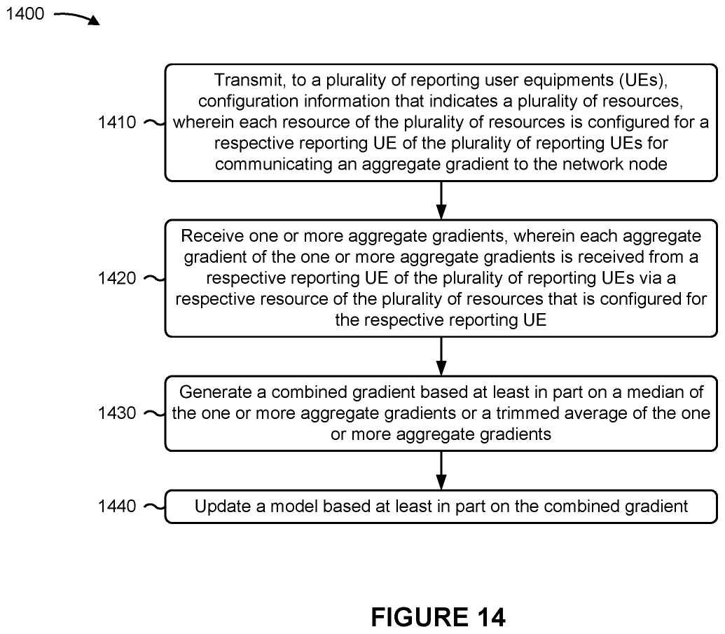

The controller/processor 240 of the network node 110, the controller/processor 280 of the UE 120, or any other component(s) of FIG. 2 may perform one or more techniques associated with gradient communication for model updating, as described in more detail elsewhere herein. For example, the controller/processor 240 of the network node 110, the controller/processor 280 of the UE 120, or any other component(s) of FIG. 2 may perform or direct operations of, for example, process 1100 of FIG. 11, process 1200 of FIG. 12, process 1300 of FIG. 13, process 1400 of FIG. 14, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1100 of FIG. 11, process 1200 of FIG. 12, process 1300 of FIG. 13, process 1400 of FIG. 14, or other processes as described herein. In some examples, executing instructions may include running the instructions, converting the instructions, compiling the instructions, or interpreting the instructions, among other examples.

In some aspects, a reporting UE (for example, the UE 120) includes means for receiving feedback that indicates a plurality of local gradients from a plurality of respective transmitter UEs via a first plurality of respective resources; means for generating a combined gradient based at least in part on a median of the plurality of local gradients or a trimmed average of the plurality of local gradients; or means for transmitting the combined gradient to a network node via a second resource that is shared by the reporting UE and at least one other reporting UE configured to transmit a respective combined gradient to the network node. The means for the reporting UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a reporting UE (for example, the UE 120) includes means for receiving feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource; or means for transmitting the aggregate gradient to a network node via a second resource, of a plurality of second resources, that is configured for communicating the aggregate gradient between the reporting UE and the network node, where each second resource of the plurality of second resources is configured for communicating an aggregate gradient between a respective reporting UE and the network node. The means for the reporting UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (for example, the network node 110) includes means for transmitting, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs; means for receiving a plurality of combined gradients from the plurality of reporting UEs based on the one or more parameters, wherein the plurality of combined gradients are received via a second resource that is shared by the plurality of reporting UEs; or means for updating a model based at least in part on the plurality of combined gradients. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network node (for example, the network node 110) includes means for transmitting, to a plurality of reporting UEs, configuration information that indicates a plurality of resources, wherein each resource of the plurality of resources is configured for a respective reporting UE of the plurality of reporting UEs for communicating an aggregate gradient to the network node; means for receiving one or more aggregate gradients, wherein each aggregate gradient of the one or more aggregate gradients is received from a respective reporting UE of the plurality of reporting UEs via a respective resource of the plurality of resources that is configured for the respective reporting UE; means for generating a combined gradient based at least in part on a median of the one or more aggregate gradients or a trimmed average of the one or more aggregate gradients; or means for updating a model based at least in part on the combined gradient. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

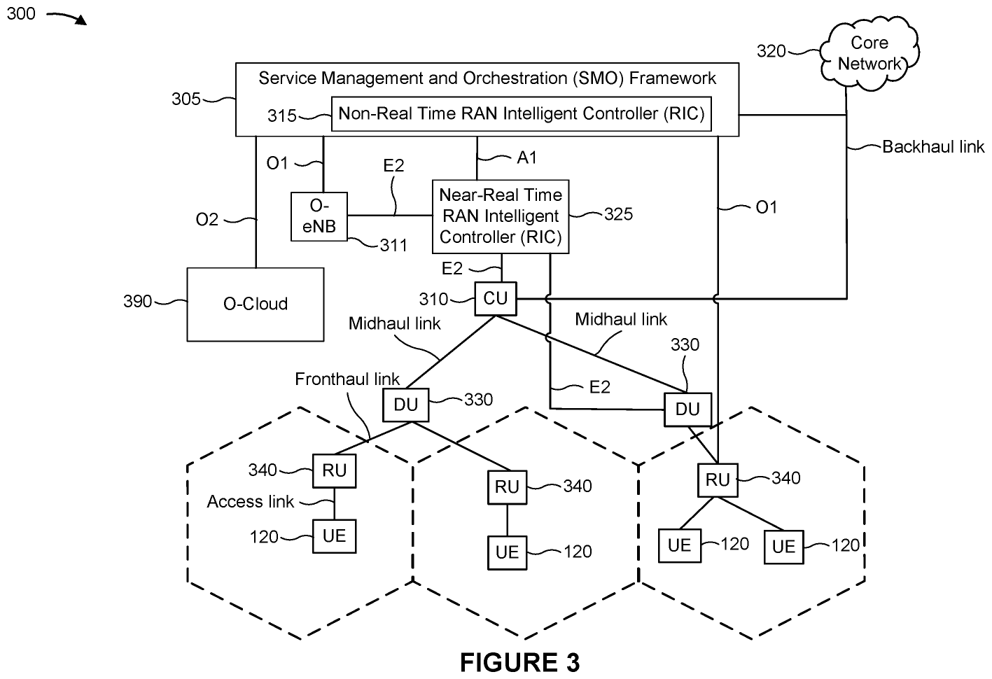

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

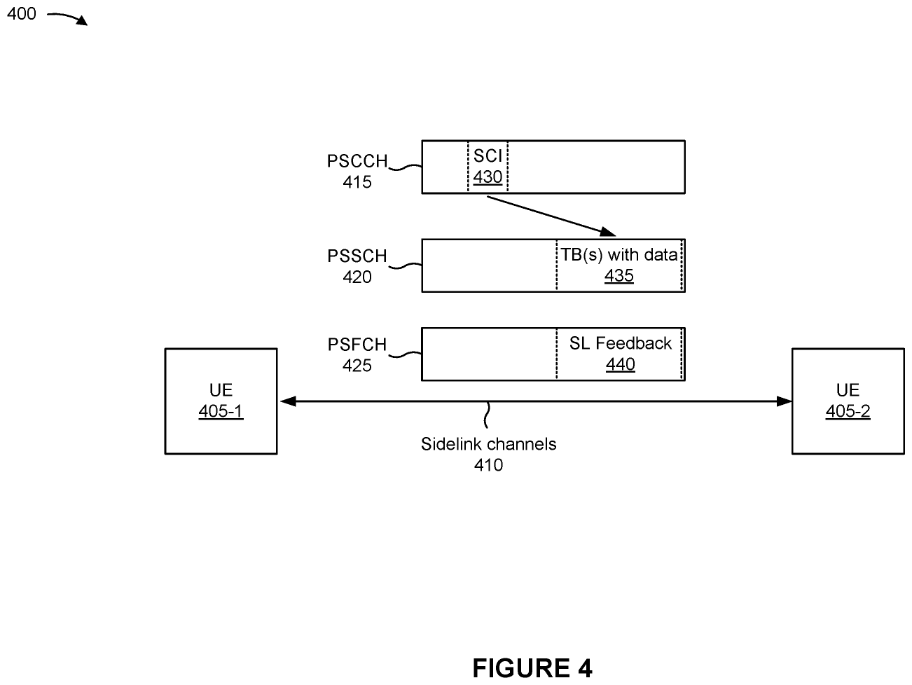

FIG. 4 is a diagram illustrating an example 400 of sidelink communications in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (for example, which may include V2V communications, V2I communications, or V2P communications), or mesh networking. In some aspects, the UEs 405 (for example, UE 405-1 or UE 405-2) may correspond to one or more other UEs described elsewhere herein, such as UE 120. In some aspects, the one or more sidelink channels 410 may use a PC5 interface or may operate in a high frequency band (for example, the 5.9 GHz band). Additionally or alternatively, the UEs 405 may synchronize timing of transmission time intervals (TTIs) (for example, frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, or a physical sidelink feedback channel (PSFCH) 425. The PSCCH 415 may be used to communicate control information, similar to a physical downlink control channel (PDCCH) or a physical uplink control channel (PUCCH) used for cellular communications with a network node 110 via an access link or an access channel. The PSSCH 420 may be used to communicate data, similar to a physical downlink shared channel (PDSCH) or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (for example, time resources, frequency resources, or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (for example, acknowledgement or negative acknowledgement (ACK/NACK) information), transmit power control (TPC), or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (for example, time resources, frequency resources, or spatial resources) on the PSSCH 420, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, or an MCS. The SCI-2 may include information associated with data transmissions on the PSSCH 420, such as a HARQ process ID, a new data indicator (NDI), a source identifier, a destination identifier, or a channel state information (CSI) report trigger.

In some aspects, the one or more sidelink channels 410 may use resource pools. For example, a scheduling assignment (for example, included in SCI 430) may be transmitted in sub-channels using specific resource blocks (RBs) across time. In some aspects, data transmissions (for example, on the PSSCH 420) associated with a scheduling assignment may occupy adjacent RBs in the same subframe as the scheduling assignment (for example, using frequency division multiplexing). In some aspects, a scheduling assignment and associated data transmissions are not transmitted on adjacent RBs.

In some aspects, a UE 405 may operate using a sidelink resource allocation mode (for example, Mode 1) where resource selection or scheduling is performed by a network node 110 (for example, a base station, a CU, or a DU). For example, the UE 405 may receive a grant (for example, in downlink control information (DCI) or in an RRC message, such as for configured grants) from the network node 110 (for example, directly or via one or more network nodes) for sidelink channel access or scheduling. In some aspects, a UE 405 may operate using a resource allocation mode (for example, Mode 2) where resource selection or scheduling is performed by the UE 405 (for example, rather than a network node 110). In some aspects, the UE 405 may perform resource selection or scheduling by sensing channel availability for transmissions. For example, the UE 405 may measure an RSSI parameter (for example, a sidelink-RSSI (S-RSSI) parameter) associated with various sidelink channels, may measure an RSRP parameter (for example, a PSSCH-RSRP parameter) associated with various sidelink channels, or may measure an RSRQ parameter (for example, a PSSCH-RSRQ parameter) associated with various sidelink channels, and may select a channel for transmission of a sidelink communication based at least in part on the measurement(s).

Additionally or alternatively, the UE 405 may perform resource selection or scheduling using SCI 430 received in the PSCCH 415, which may indicate occupied resources or channel parameters. Additionally or alternatively, the UE 405 may perform resource selection or scheduling by determining a channel busy ratio (CBR) associated with various sidelink channels, which may be used for rate control (for example, by indicating a maximum quantity of resource blocks that the UE 405 can use for a particular set of subframes).

In the resource allocation mode where resource selection or scheduling is performed by a UE 405, the UE 405 may generate sidelink grants, and may transmit the grants in SCI 430. A sidelink grant may indicate, for example, one or more parameters (for example, transmission parameters) to be used for an upcoming sidelink transmission, such as one or more resource blocks to be used for the upcoming sidelink transmission on the PSSCH 420 (for example, for TBs 435), one or more subframes to be used for the upcoming sidelink transmission, or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally or alternatively, the UE 405 may generate a sidelink grant for event-driven scheduling, such as for an on-demand sidelink message

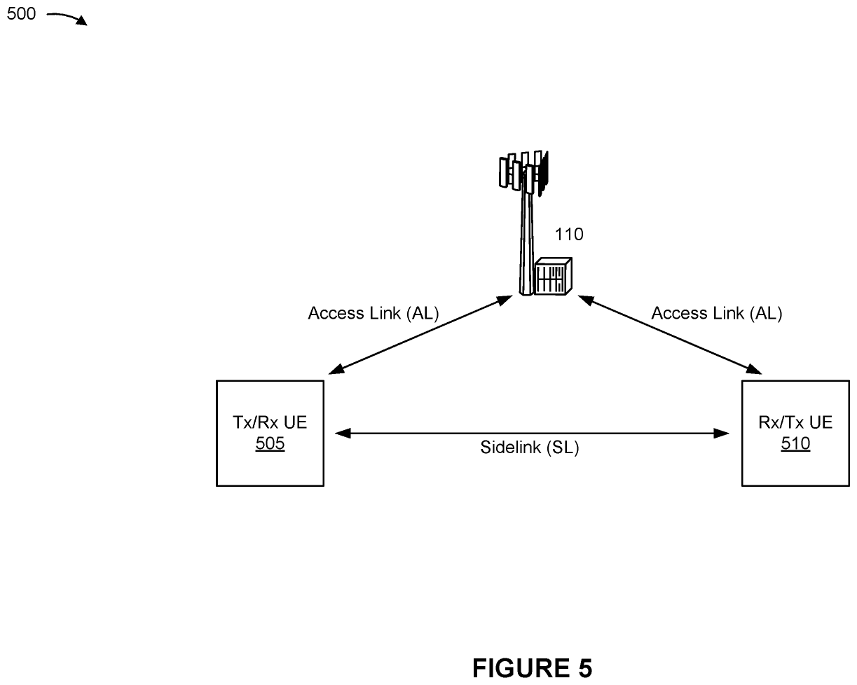

FIG. 5 is a diagram illustrating an example 500 of sidelink communications and access link communications in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (for example, directly or via one or more network nodes), such as via a first access link. Additionally or alternatively, in some sidelink modes, the network node 110 may communicate with the Rx/Tx UE 510 (for example, directly or via one or more network nodes), such as via a first access link. The Tx/Rx UE 505 or the Rx/Tx UE 510 may correspond to one or more UEs described elsewhere herein, such as the UE 120 of FIG. 1. Thus, a direct link between UEs 120 (for example, via a PC5 interface) may be referred to as a sidelink, and a direct link between a network 110 and a UE 120 (for example, via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

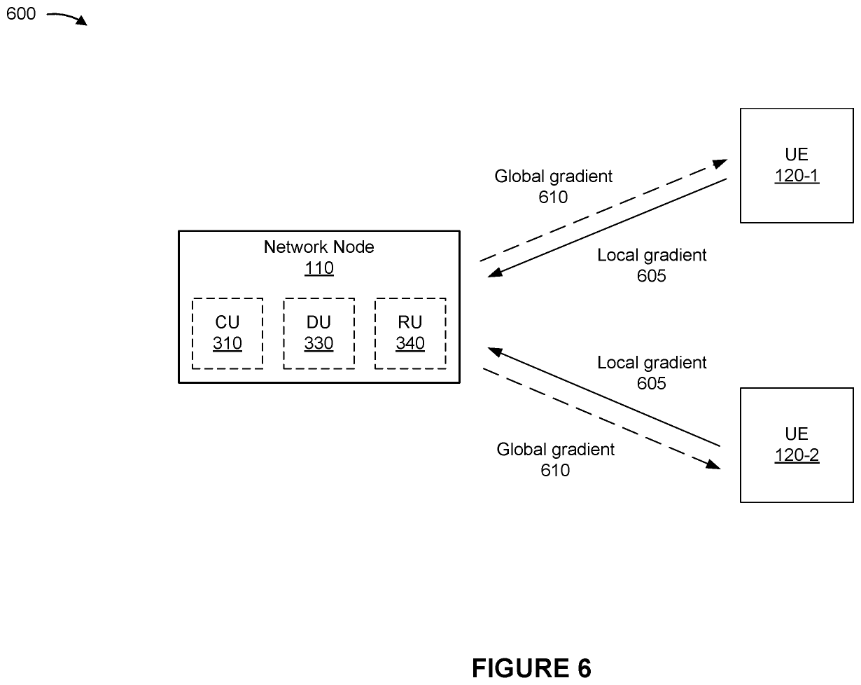

FIG. 6 is a diagram illustrating an example model 600 in accordance with the present disclosure. The network node 110 may communicate with a plurality of UEs 120, such as the UE 120-1 and the UE 120-2. The network node 110 may include some or all of the features of the CU 310, the DU 330, or the RU 340 described herein, among other examples.

In some cases, the model 600 may be a model for federated learning (for example, a federated learning model). Federated learning may enable multiple UEs 120 (such as the UE 120-1 and the UE 120-2) to be configured with a common model, and to use local computation power to refine the model. In some cases, the federated learning model may be a neural network model. The model may be used for keyword prediction, voice prediction, or for predicting future RSRP measurements based at least in part on previous RSRP measurements for different beams in an area, among other examples. In some cases, the model may be refined based at least in part on updates to the model. The updates to the model may reduce error rates based at least in part on applications of the model. In some cases, different UEs configured with the model may have access to different sets of data that can be used to compute a local update for the model. For example, the UE 120-1 may compute a first local update for the model based at least in part on data that is available to the UE 120-1, and the UE 120-2 may compute a second local update for the model based at least in part on data that is available to the UE 120-2. In some cases, the local update to the model may be a gradient. The gradient may be a derivative that is determined based at least in part on applying the local data to the model. In some cases, the gradient of the model parameters may be a vector, where a p^{th} entry of the vector is a partial derivative of a p^{th} parameter with respect to a training loss.

In some cases, the update to the model may occur in multiple iterations. For example, the UE 120-1 and the UE 120-2 may each compute a local gradient (such as a local gradient 605) using local data, and may send the local gradients to the network node 110. The network node 110 (for example, the CU 310) may compute a global update to the model (for example, a global gradient 610) using the local updates from the UE 120-1 and the UE 120-2. In some cases, the global gradient may be determined based at least in part on the following:

$${g}_{G l o b a l}^{( n )} = \frac{1}{\sum {S}_{k}} {\sum }_{k} {S}_{k} {g}_{k}^{( n )} ,$$

where
g_{Global}⁽ⁿ⁾ is the global gradient,
gₖ⁽ⁿ⁾ is the local gradient of UE k, and
Sₖ is the size of the database which UE k uses to compute the local gradient for the UE k.

The network node 110 may transmit the global update (for example, the global gradient 610) to each of the UE 120-1 and the UE 120-2. After receiving the global update, the UE 120-1 and the UE 120-2 may update one or more parameters using the global update. In some cases, the updated parameters for an iteration of the model may be determined based at least in part on the following:

w⁽ⁿ⁺¹⁾=w⁽ⁿ⁾−ηg_{Global}⁽ⁿ⁾, where
w⁽ⁿ⁺¹⁾ is an updated parameter,
w⁽ⁿ⁾ is a parameter for a previous iteration, and
η is a scalar value that is provided by the network node 110.

Federated learning may enable back-propagation that is computed locally at the edge nodes (for example, the UE 120-1 and the UE 120-2). In some cases, the UE 120-1 and the UE 120-2 may only transmit the parameter updates to the network node 110 without sending the raw data (for example, without sending any raw data, or only sending a portion of the raw data). This may result in less overall data traffic and may enhance user privacy.

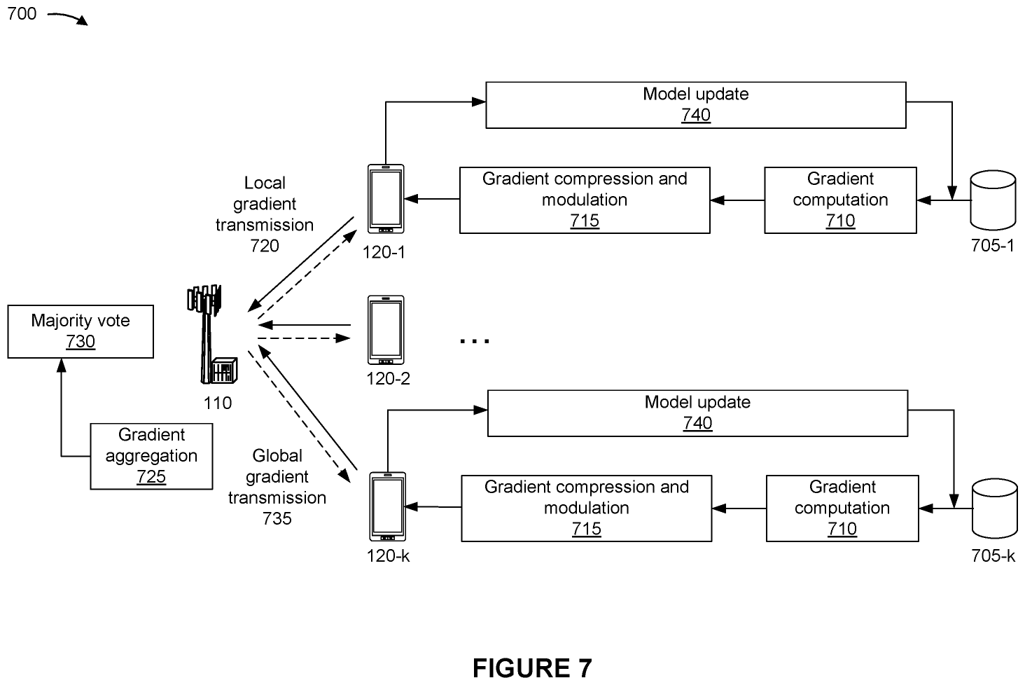

FIG. 7 is a diagram illustrating an example 700 of gradient feedback in accordance with the present disclosure. As described herein, the local gradient may be a vector, and a size of the vector may correspond to a quantity of parameters that are included in the model. In some cases, the gradient feedback may be digital feedback or analog feedback (for example, OTA feedback). For both digital feedback and analog feedback, the UE 120 may need to transmit each entry of the local gradient individually using different resources.

When using digital feedback, each UE 120 may be configured with dedicated resources (for example, resources that are specific to the respective UE 120) for sending the local gradient corresponding to the UE 120. For example, the UE 120-1 may be configured with first resources for sending a local gradient vector corresponding to the UE 120-1, and the UE 120-2 may be configured with second resources for sending a local gradient vector corresponding to the UE 120-2. In some cases, each entry of the gradient may be encoded in digital bits as a normal data package. If there are K UEs 120, and the length of the gradient vector is M, the total quantity of resources that are needed to send the gradient vectors from all of the UEs 120 may be K*M. In some cases, because the network node 110 receives the local gradients from each UE 120 using different resources, the network node 110 may be able to determine which UE 120 sent a particular gradient vector.

When using analog feedback, all UEs 120 may use the same resource(s) for sending the local gradient vectors. For example, the UE 120-1 may use a resource for sending the local gradient vector associated with the UE 120-1, and the UE 120-2 may use the same resource for sending the local gradient vector associated with the UE 120-2. The resources that are needed for transmitting the gradient feedback may correspond to the length of the gradient vector K (regardless of the quantity of UEs). Thus, analog feedback may use fewer resources than digital feedback. In some cases, an analog waveform may be used to indicate the magnitude of the gradients. For example, the analog waveforms from different UEs 120 may be aggregated over the air, and the network node 110 may receive the aggregated versions of all analog waveforms from the different UEs 120. The aggregation over the air may act as a summation of all local gradients. In such examples, the network node 110 may be able to determine the global gradient vector based at least in part on detecting the aggregated waveform. However, the network node 110 may not be able to determine the individual vectors (for example, the local gradients) associated with each of the respective UEs 120.

As shown in FIG. 7, the UE 120 (for example, an edge device) may be associated with a local dataset 705. The local dataset 705 may include data associated with the UE 120 that may be used to update a federated learning model. While the example 700 shows the network node 110 communicating with three UEs 120 (e.g., UE 120-1, UE 120-2, and UE 120-k), the network node 110 may communicate with any number of UEs 120, and each UE 120 may be associated with any number of models. In an example operation 710, the UE 120 may perform gradient computation for computing one or more gradients. For example, the UE 120-k may compute a local gradient gₖ⁽ⁿ⁾ based at least in part on the local dataset 705-k and a current iteration of the model, where k is the index associated with the UE 120 and n is the number of parameter updates associated with the model.

In an example operation 715, the UE 120 may perform gradient compression and modulation. The UE 120 may perform the gradient compression and modulation to determine whether the local gradient has a positive value (“+”) or a negative value (“−”). For example, the UE 120 may calculate the following:

\check{g}ₖ⁽ⁿ⁾=sign(gₖ⁽ⁿ⁾), where
\check{g}ₖ⁽ⁿ⁾ is a positive value or a negative value that is based at least in part on the local gradient gₖ⁽ⁿ⁾.

In an example operation 720, each UE 120 may transmit the local gradient corresponding to the respective UE 120. The local gradients may be transmitted using OTA transmission, as described herein. For example, the UE 120-1 may transmit the local gradient associated with the UE 120-1 using a channel associated with the UE 120-1, and the UE 120-k may transmit the local gradient associated with the UE 120-k using a channel associated with the UE 120-k.

In an example operation 725, the network node 110 may perform gradient aggregation to aggregate the local gradients received from the respective UEs 120. For example, the network node 110 perform the gradient aggregation of the local gradients based on calculating the following:

yₙ=Σₖ₌₁^{K}gₖ⁽ⁿ⁾, where
yⁿ is the aggregated gradient, and
gₖ⁽ⁿ⁾ are the local gradients received from the UEs 120 (e.g., from UE 120-1, UE 120-2, and UE 120-k) via the respective channels.

In an example operation 730, the network node 110 may perform a majority vote. For example, the network node 110 may perform the majority vote based at least in part on v⁽ⁿ⁾=sign(y⁽ⁿ⁾), where v⁽ⁿ⁾ is the global gradient that is computed by the network node 110. In this example, each entry of the local gradient may be encoded into the sign of the analog waveform (for example, “+” or “−”). In some cases, the magnitude of the waveform may be based at least in part on the size of the local dataset that is used to compute the local gradient.

In an example operation 735, the network node 110 may transmit the global gradient v⁽ⁿ⁾ to the UEs 120. For example, the network node 110 may transmit the global gradient to the UE 120-1 using the channel associated with the UE 120-1, and may transmit the global gradient to the UE 120-k using the channel associated with the UE 120-k.

In an example operation 740, the UE 120 may update the model based at least in part on the global gradient. For example, the UE 120-1 may update the model associated with the UE 120-1 based at least in part on the global gradient, and the UE 120-k may update the model associated with the UE 120-k based at least in part on the global gradient. In some cases, the UE 120 may update the model based at least in part on calculating the following:

w⁽ⁿ⁾=w⁽ⁿ⁻¹⁾−η*v⁽ⁿ⁻¹⁾, where
w⁽ⁿ⁾ is the vector of updated parameters of the model in iteration n,
w⁽ⁿ⁻¹⁾ is the vector of the model parameter corresponding to previous iteration of the model,
η is a scalar value that is provided by the network node 110, and
v⁽ⁿ⁻¹⁾ the global update of the model parameters indicated by the network node 110.

In some cases, analog feedback from the UEs 120 to the network node 110 may be coherently combined based at least in part on differences in the channels between the respective UEs 120 and the network node 110. For example, the UEs 120 may pre-compensate the respective channel affects, such as by using channel inversion. In one example, a truncated channel inversion pₖ may be calculated based at least in part on an intended received power ρₖ and based at least in part on the channel hₖ that is used for communicating the gradient. In some cases, pₖ[m] may be equal to (\sqrt{ρₖ}[m])/(hₖ[m]) when |hₖ[m]|² is greater than, or greater than or equal to, a threshold. Alternatively, ρₖ[m] may be equal to 0 when |hₖ[m]|² is less than the threshold. In this case, the UE 120 may cancel the channel inversion when the channel inversion requires a power level that is greater than a power level threshold. In some cases, ρₖ may be proportional to the local database set size Sₖ. Additionally, or alternatively, ρₖ may be configured by the network node 110 for a reference size of the database (for example, a database of size 1).

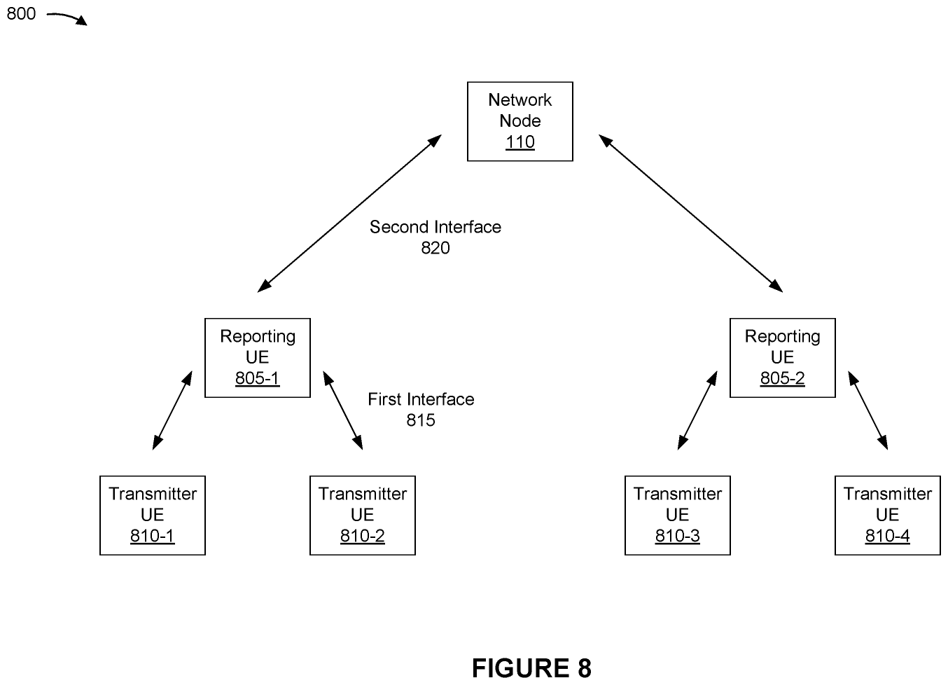

FIG. 8 is a diagram illustrating an example 800 of gradient feedback communication in accordance with the present disclosure. The network node 110 may communicate with one or more reporting UEs 805, such as the reporting UE 805-1 and the reporting UE 805-2. Each reporting UE 805 may communicate with one or more transmitter UEs 810. For example, the reporting UE 805-1 may communicate with the transmitter UE 810-1 and the transmitter UE 810-2, and the reporting UE 805-2 may communicate with the transmitter UE 810-3 and the transmitter UE 810-4. The reporting UE 805 may include some or all of the features of the UE 120. Additionally or alternatively, the transmitter UE 810 may include some or all of the features of the UE 120.

In some cases, the reporting UEs 805 may be configured to transmit gradients associated with the transmitter UEs 810. For example, the reporting UE 805-1 may receive a first gradient from the transmitter UE 810-1 and a second gradient from the transmitter UE 810-2. The reporting UE 805-1 may receive the first gradient and the second gradient via the first interface 815. The first interface 815 may be a sidelink interface, such as a PC5 interface. Similarly, the reporting UE 805-2 may receive a third gradient from the transmitter UE 810-3 and a fourth gradient from the transmitter UE 810-4. The reporting UE 805-2 may receive the third gradient and the fourth gradient via the sidelink interface. The reporting UE 805-1 and the reporting UE 805-2 may transmit local gradients to the network node 110 via a second interface 820. The second interface 820 may be a radio link interface, such as a Uu interface. For example, the reporting UE 805-1 may transmit the first gradient and the second gradient (or another gradient associated with the reporting UE 805-1) to the network node 110 via the Uu interface, and the reporting UE 805-2 may transmit the third gradient and the fourth gradient (or another gradient associated with the reporting UE 805-2) to the network node 110 via the Uu interface.

In some cases, the network node 110 may configure the grouping of the UEs. For example, the network node 110 may configure the reporting UE 805-1 to report the local gradients for the transmitter UE 810-1 and the transmitter UE 810-2 and may configure the reporting UE 805-2 to report the local gradients for the transmitter UE 810-3 and the transmitter UE 810-4. In some cases, the distance between the reporting UE 805 and the transmitter UE 810 may be small compared to the distance between the reporting UEs 805 and the network node 110. For example, the distance between the reporting UEs 805 and the network node 110 may be greater than the distance between the reporting UEs 805 and the transmitter UEs 810. Thus, lower transmit power can be used for communications between the reporting UEs 805 and the transmitter UEs 810. Additionally, sidelink resources can be reused among the different UE groups, which may result in better resource efficiency. However, the first interface 815 (for example, the sidelink interface) and the second interface 820 (for example, the Uu interface) may both be OTA interfaces that are configured for analog feedback. This may result in at least some of the UEs not being trustworthy.

In some cases, the UE may transmit an arbitrary gradient or an adversarial gradient to the network node. An arbitrary gradient may be a gradient that is incorrectly determined by the UE, such as a gradient that is calculated based at least in part on an incorrect dataset. An adversarial gradient may be a gradient that is intended to corrupt the model, such as the federated learning model. The arbitrary gradient or the adversarial gradient may cause the model to suffer from performance loss or may cause convergence issues. The network node may be able to detect whether the gradient or the UE is trustworthy when the gradient is received from the UE using digital feedback. The network node may be able to identify the UE that sent the gradient, such as based at least in part on authenticating the UE or based at least in part on resources that were used by the UE to transmit the gradient. In some cases, the network node may keep track of the gradients from the each of a plurality of UEs, and may initiate a clustering algorithm to determine whether the trajectory from the UE is an outlier (for example, as compared to the gradients received from other UEs). Gradients received from the UE may be removed from future averaging of gradients, or the UE may be required to provide further authentication, based at least in part on the network node determining that the UE is transmitting arbitrary gradients or adversarial gradients. However, when analog feedback (for example, OTA aggregation) is used, the network node may only receive the aggregated sum of the gradients, and may not be able to determine the individual gradients from each of the respective UEs. Thus, the network node may not be able to determine whether the feedback includes an arbitrary gradient or an adversarial gradient, and may not be able to identify which of the UEs sent the arbitrary gradient or the adversarial gradient. This may increase the likelihood that the model becomes corrupted.

Techniques and apparatuses are described herein for gradient communication for model updating. In some aspects, a reporting UE may receive feedback (such as digital feedback) that includes a plurality of local gradients from a plurality of respective transmitter UEs via a first set of resources. The reporting UE may generate a combined gradient based at least in part on a median of the plurality of local gradients or a trimmed average of the plurality of local gradients. The reporting UE may transmit the combined gradient to a network node via a second resource that is shared by the reporting UE and at least one other reporting UE configured to transmit a respective combined gradient to the network node (for example, using OTA feedback). In some aspects, a reporting UE may receive feedback (such as OTA feedback) that includes an aggregate gradient via a first resource that is shared by a plurality of transmitter UEs. The aggregate gradient may be an aggregate of a plurality of local gradients that are transmitted by each transmitter UE of the plurality of transmitter UEs via the first resource. The reporting UE may transmit the aggregate gradient to the network node via a second resource that is configured for communicating the aggregate gradient between the reporting UE and the network node (for example, using digital feedback). The network node may generate a combined gradient based at least in part on the aggregate gradient, and may update a model based at least in part on the combined gradient.

As described above, the reporting UE may be configured to transmit local gradients for one or more transmitter UEs that are included within a group associated with the reporting UE. In some cases, one or more of the transmitter UEs within the group may transmit an arbitrary gradient or an adversarial gradient to the network node. This may cause performance loss in the trained model or may cause convergence issues. When gradients are received using digital feedback, the network node may be able to determine whether the gradients are trustworthy. However, when gradients are received using analog feedback, the network node may only receive the aggregated sum of all gradients, and may not be able to determine whether the feedback includes an arbitrary gradient or an adversarial gradient. This may increase the likelihood that the model becomes corrupted. Using the techniques and apparatuses described herein, at least one of the reporting UE or the network node may receive the local gradients via digital feedback. This may enable the reporting UE or the network node to identify an arbitrary gradient or an adversarial gradient in a sidelink communication, thereby decreasing the likelihood of the model becoming corrupted.

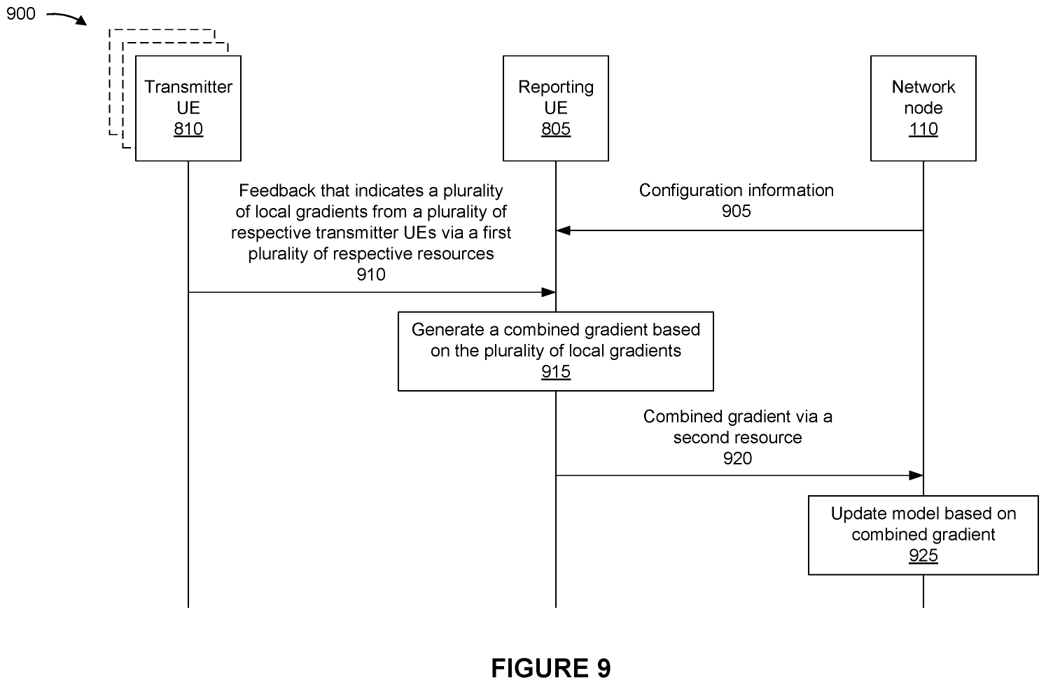

FIG. 9 is a diagram illustrating an example 900 of gradient communication for model updating in accordance with the present disclosure. As shown in FIG. 9, a reporting UE 805 may communicate with a network node 110 and one or more transmitter UEs 810. The network node 110, the reporting UE 805, and the one or more transmitter UEs 810 may be configured with a model (for example, a federated learning model). For example, each of the network node 110, the reporting UE 805, and the one or more transmitter UEs 810 may be configured with one or more instances of the model 600.

In an example operation 905, the network node 110 may transmit, and the reporting UE 805 may receive, configuration information. The configuration information may indicate one or more parameters for generating a combined gradient based at least in part on a plurality of local gradients. In some aspects, the configuration information may include information for generating a median gradient or a trimmed average gradient based at least in part on the plurality of local gradients. For example, the configuration information may indicate a percentage of local gradients that are to be ignored when generating the trimmed average gradient. In some aspects, the configuration information may include information associated with one or more resources to be used for transmitting gradients. For example, the configuration information may indicate respective first resources (for example, digital resources) to be used by respective transmitter UEs 810 for transmitting local gradients to the reporting UE 805. Additionally or alternatively, the configuration information may indicate a second resource (for example, an analog resource) to be used by the reporting UE 805 to transmit a combined gradient to the network node 110. Additional details regarding these features are described below.

In some aspects, the configuration information may include information for grouping the reporting UE 805 and the one or more transmitter UEs 810. For example, the configuration information may indicate that a select reporting UE 805 and a select plurality of transmitter UEs 810 are to be included in a group. Additionally or alternatively, the configuration information may indicate that the select reporting UE 805 is to transmit gradient information, associated with the select reporting UE 805 and the select plurality of transmitter UEs 810, to the network node 110. In some aspects, the configuration information may include information that enables the reporting UE(s) 805 or the transmitter UE(s) 810 to form one or more groups. In some other aspects, the network node 110 may explicitly indicate the reporting UE(s) 805 and the transmitter UE(s) 810 that are to be included in a group. For example, the network node 110 may form L groups, and each group of the L groups may be assigned a reporting UE 805. The reporting UE 805 may be a trusted UE (such as a roadside unit (RSU)) or a UE that has been authenticated by the network node 110. In some aspects, the reporting UE 805 may be randomly selected for each round of transmitting the gradient information. For example, the reporting UE 805 may be randomly selected from a set of UEs, such as a set of trusted UEs or a set of authenticated UEs, each time that gradient information associated with the group (of the L groups) is to be transmitted to the network node 110.

In an example operation 910, the reporting UE 805 may receive feedback that indicates a plurality of local gradients. For example, the reporting UE 805 may receive feedback, that indicates the plurality of local gradients, from a plurality of transmitter UEs 805 via a first plurality of resources. A respective local gradient of the plurality of local gradients may be received via a respective resource of the first plurality of resources that is associated with a respective transmitter UE 810 of the plurality of transmitter UEs 810. For example, a respective transmitter UE 810 may transmit a respective local gradient using a respective resource of the first plurality of resources.

In some aspects, each resource of the first plurality of resources may a digital feedback resource. In such examples, each transmitter UE 810 of the plurality of transmitter UEs 810 may be configured with dedicated resources for sending the local gradient associated with the respective transmitter UE 810. For example, a first transmitter UE 810 may be configured with a first dedicated resource(s) for sending a local gradient associated with the first transmitter UE 810, and a second transmitter UE 810 may be configured with a second dedicated resource(s) for sending a local gradient associated with the second transmitter UE 810. In some aspects, each entry of the local gradient may be encoded in digital bits as a data package. In such examples, if there are K transmitter UEs 810, and the length of the gradient vector(s) is M, the quantity of resources that may be needed to transmit the gradient vectors from all of the transmitter UEs 810 may be K*M.

In an example operation 915, the reporting UE 805 may generate a combined gradient. In some aspects, the reporting UE 805 may generate the combined gradient based at least in part on a median of the plurality of local gradients or a trimmed average of the plurality of local gradients. In some aspects, the reporting UE 805 may generate the combined gradient based at least in part on the configuration information received from the network node 110. For example, the configuration information may indicate for the reporting UE 805 to generate the trimmed average gradient based at least in part on ignoring a percentage of the local gradients (such as a top ten percent of the local gradients and a bottom ten percent of the local gradients). For example, if the reporting UE 805 receives one hundred local gradients from one hundred respective transmitter UEs 810, the reporting UE 805 may generate a combined gradient that is based at least in part on eighty of the local gradients (for example, not including the ten local gradients having the lowest values and the ten local gradients having the highest values). In some aspects, the median gradient or the trimmed average gradient may be less impacted by an outlier gradient (for example, an arbitrary gradient or an adversarial gradient) than an average gradient would be impacted by the outlier gradient. For example, the outlier gradient may not be factored into the computation of the combined gradient when the combined gradient is generated using a trimmed average.

In an example operation 920, the reporting UE 805 may transmit, and the network node 110 may receive, the combined gradient via a second resource. The second resource may be a resource that is shared by the reporting UE 805 and at least one other reporting UE 805. In some aspects, the second resource may be configured for analog feedback (for example, OTA feedback). In such examples, the reporting UE 805 may transmit the gradient, such as the median gradient or the trimmed average gradient, to the network node 110 via the analog feedback.

In some aspects, when using analog feedback, a plurality of reporting UEs 805 may use the same resource(s) for sending the combined gradient. For example, a first reporting UE 805 may use a select resource for sending the combined gradient associated with the first reporting UE 805, and a second reporting UE 805 may use the same select resource for sending the combined gradient associated with the second reporting UE 805. The resources that are needed for transmitting the combined gradients may correspond to the length of the gradient vector K (regardless of the quantity of UEs). In some aspects, an analog waveform may be used to indicate the magnitude of the combined gradient. For example, the analog waveforms from different reporting UEs 805 may be aggregated over the air, and the network node 110 may receive the aggregated versions of all analog waveforms from the different reporting UEs 805. The aggregation over the air may act as a summation of all of the combined gradients. As described herein, because the plurality of combined gradients are received via analog feedback, the network node 110 may not be able to determine whether a particular combined gradient is an outlier gradient, such as an arbitrary gradient or an adversarial gradient. However, the plurality of combined gradients may be considered to be trustworthy because the plurality of combined gradients have been computed by the respective reporting UE(s) based at least in part on the median of the local gradients or the trimmed average of the local gradients.

In an example operation 925, the network node 110 may update a model based at least in part on the combined gradient. In some aspects, the model may be a federated learning model. In some aspects, the combined gradient may be a gradient vector that indicates an update to the model, and the network node 110 may update the model based at least in part on the gradient vector. Additionally or alternatively, the network node 110 may generate a global gradient associated with the update to the model, and may transmit the global gradient to a plurality of UEs (such as the reporting UE(s) 805 or the transmitter UE(s) 810). The plurality of UEs may update respective models associated with the plurality of UEs based at least in part on the global gradient, and may generate further updates to the model (for example, local gradients) based at least in part on respective local data associated with the plurality of UEs. As described herein, at least one of the local gradient(s) or the combined gradient(s) may be transmitted using digital feedback. This may enable the reporting UE 805 or the network node 110 to identify an arbitrary gradient or an adversarial gradient, thereby decreasing the likelihood of the model becoming corrupted.

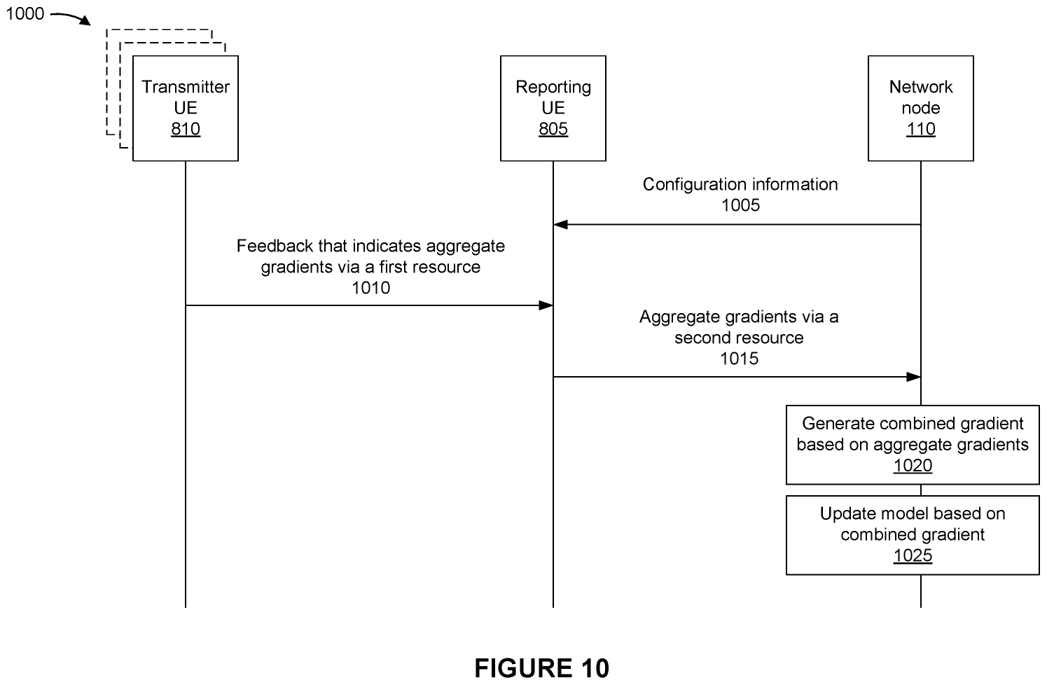

FIG. 10 is a diagram illustrating an example 1000 of gradient communication for model updating in accordance with the present disclosure. As shown in FIG. 10, a reporting UE 805 may communicate with a network node 110 and one or more transmitter UEs 810. The network node 110, the reporting UE 805, and the one or more transmitter UEs 810 may be configured with a model (for example, a federated learning model). For example, each of the network node 110, the reporting UE 805, and the one or more transmitter UEs 810 may be configured with one or more instances of the model 600.

In an example operation 1005, the network node 110 may transmit, and the reporting UE 805 may receive, configuration information. In some aspects, the configuration information may include information associated with one or more resources to be used for transmitting gradients. For example, the configuration information may indicate a first resource (for example, an analog resource) to be used by the transmitter UE(s) 810 for transmitting feedback to the reporting UE 805. Additionally or alternatively, the configuration information may indicate one or more second resources (for example, digital resources) to be used by respective reporting UEs 805 for transmitting respective aggregated gradients to the network node 110. Additional details regarding these features are described below.

In some aspects, the configuration information may include information for grouping the reporting UE 805 and the one or more transmitter UEs 810. For example, the configuration information may indicate that a select reporting UE 805 and a select plurality of transmitter UEs 810 are to be included in a group. Additionally or alternatively, the configuration information may indicate that the select reporting UE 805 is to transmit gradient information, associated with the select reporting UE 805 and the select plurality of transmitter UEs 810, to the network node 110. In some aspects, the configuration information may include information that enables the reporting UE(s) 805 or the transmitter UE(s) 810 to form one or more groups. In some other aspects, the network node 110 may explicitly indicate the reporting UE(s) 805 and the transmitter UE(s) 810 that are to be included in a group. For example, the network node 110 may form L groups, and each group of the L groups may be assigned a reporting UE 805. The reporting UE 805 may be a trusted UE (such as an RSU) or a UE that has been authenticated by the network node 110. In some aspects, the reporting UE 805 may be randomly selected for each round of transmitting the gradient information. For example, the reporting UE 805 may be randomly selected from a set of UEs, such as a set of trusted UEs or a set of authenticated UEs, each time that gradient information associated with the group (of the L groups) is to be transmitted to the network node 110.

In an example operation 1010, one or more transmitter UEs 810 may transmit, and the reporting UE 805 may receive, feedback that indicates an aggregate gradient. The feedback that indicates the aggregate gradient may be received via a first resource (for example, an analog resource) that is shared by a plurality of transmitter UEs 810 for communicating with the reporting UE 805. In some aspects, the aggregate gradient may be an aggregate of a plurality of local gradients that are respectively transmitted by the plurality of transmitter UEs 810. For example, the aggregate gradient may be the aggregate gradient yⁿ described above in connection with FIG. 7.

In some aspects, when transmitting the analog feedback, a plurality of transmitter UEs 810 may use the same resource (for example, the analog resource) for sending local gradients. For example, a first transmitter UE 810 may use a resource for sending a local gradient associated with the first transmitter UE 810, and a second transmitter UE 810 may use the same resource for sending a local gradient associated with the second transmitter UE 810. The resources that are needed for transmitting the local gradients may correspond to the length of the gradient vector K (regardless of the quantity of UEs). In some aspects, an analog waveform may be used to indicate the magnitude of a local gradient. For example, the analog waveforms from different transmitter UEs 810 may be aggregated over the air, and the reporting UE 805 may receive the aggregated versions of all analog waveforms from the different transmitter UEs 810. The aggregation over the air may act as a summation of all of the local gradients.

In an example operation 1015, the reporting UE 805 may transmit, and the network node 110 may receive, the aggregate gradient via a second resource. For example, the reporting UE 805 may transmit the aggregate gradient via the second resource (for example, a digital resource) that is configured for communicating the aggregate gradient between the reporting UE 805 and the network node 110.

In some aspects, the network node 110 may receive a plurality of aggregate gradients from a plurality of reporting UEs 805. For example, a respective aggregate gradient of the plurality of aggregate gradients may be received via a respective resource, of a second plurality of resources, that is associated with a respective reporting UE 805 of the plurality of reporting UEs 805. In some aspects, each resource of the second plurality of resources may a digital feedback resource. In such examples, each reporting UE 805 of the plurality of reporting UEs 805 may be configured with dedicated resources for sending the aggregate gradient associated with the respective reporting UE 805. For example, a first reporting UE 805 may be configured with a first dedicated resource(s) for sending an aggregate gradient associated with the first reporting UE 805, and a second reporting UE 805 may be configured with a second dedicated resource(s) for sending an aggregate gradient associated with the second reporting UE 805. In some aspects, each entry of the aggregate gradient may be encoded in digital bits as a data package.

In an example operation 1020, the network node 110 may generate a combined gradient. For example, the network node 110 may generate a combined gradient that is based at least in part on a median of the one or more aggregate gradients or a trimmed average of the one or more aggregate gradients. In some aspects, the network node 110 may generate the trimmed average of the one or more aggregate gradients based at least in part on ignoring a percentage of the aggregate gradients (such as a top twenty percent of the aggregate gradients and a bottom twenty percent of the aggregate gradients). For example, if the network node 110 receives ten aggregate gradients from ten respective reporting UEs 805, the network node 110 may generate a combined gradient that is based at least in part on six of the aggregate gradients (for example, not including the two aggregate gradients having the lowest values and the two aggregate gradients having the highest values).

In an example operation 1025, the network node 110 may update a model based at least in part on the combined gradient. In some aspects, the model may be a federated learning model. In some aspects, the combined gradient may be a gradient vector that indicates an update to the model, and the network node 110 may update the model based at least in part on the gradient vector. Additionally or alternatively, the network node 110 may generate a global gradient associated with the update to the model, and may transmit the global gradient to a plurality of UEs (such as the reporting UE(s) 805 or the transmitter UE(s) 810). The plurality of UEs may update respective models associated with the plurality of UEs based at least in part on the global gradient, and may generate further updates to the model (for example, local gradients) based at least in part on respective local data associated with the plurality of UEs. As described herein, at least one of the local gradient(s) or the aggregate gradient(s) may be transmitted using digital feedback. This may enable the reporting UE 805 or the network node 110 to identify an arbitrary gradient or an adversarial gradient, thereby decreasing the likelihood of the model becoming corrupted.

FIG. 11 is a flowchart illustrating an example process 1100 performed, for example, by a reporting UE that supports gradient communication for model updating in accordance with the present disclosure. Example process 1100 is an example where the reporting UE (for example, UE 120 or reporting UE 805) performs operations associated with gradient communication for model updating.

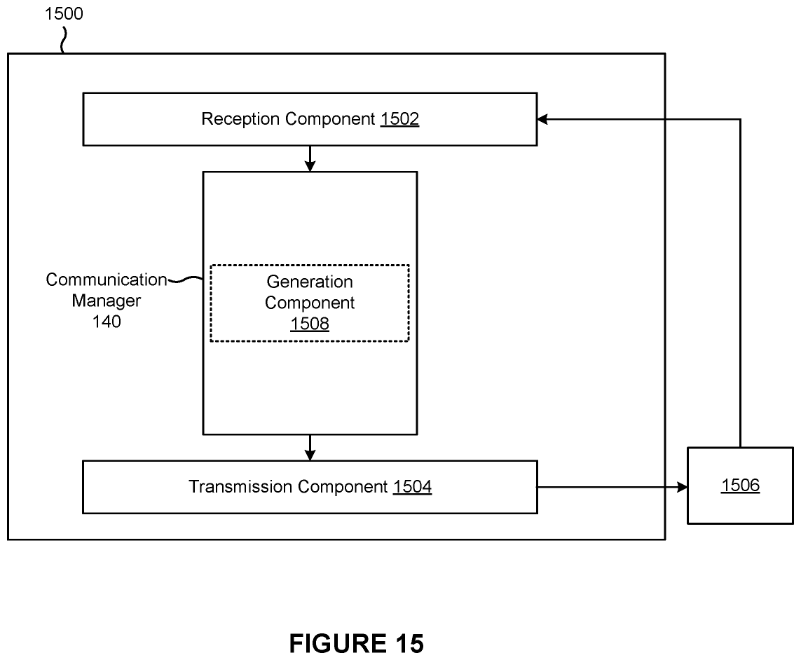

As shown in FIG. 11, in some aspects, process 1100 may include receiving feedback that indicates a plurality of local gradients from a plurality of respective transmitter UEs via a first plurality of respective resources (block 1110). For example, the reporting UE (such as by using communication manager 140 or reception component 1502, depicted in FIG. 15) may receive feedback that indicates a plurality of local gradients from a plurality of respective transmitter UEs via a first plurality of respective resources, as described above.

As further shown in FIG. 11, in some aspects, process 1100 may include generating a combined gradient based at least in part on a median of the plurality of local gradients or a trimmed average of the plurality of local gradients (block 1120). For example, the reporting UE (such as by using communication manager 140 or generation component 1508, depicted in FIG. 15) may generate a combined gradient based at least in part on a median of the plurality of local gradients or a trimmed average of the plurality of local gradients, as described above.

As further shown in FIG. 11, in some aspects, process 1100 may include transmitting the combined gradient to a network node via a second resource that is shared by the reporting UE and at least one other reporting UE configured to transmit a respective combined gradient to the network node (block 1130). For example, the reporting UE (such as by using communication manager 140 or transmission component 1504, depicted in FIG. 15) may transmit the combined gradient to a network node via a second resource that is shared by the reporting UE and at least one other reporting UE configured to transmit a respective combined gradient to the network node, as described above.

Process 1100 may include additional aspects, such as any single aspect or any combination of aspects described below or in connection with one or more other processes described elsewhere herein.

In a first additional aspect, each local gradient of the plurality of local gradients is encoded into one or more bits, and the one or more bits are associated with a select resource of the first plurality of respective resources.

In a second additional aspect, alone or in combination with the first aspect, receiving the plurality of local gradients from the plurality of respective transmitter UEs via the first plurality of respective resources includes receiving a first local gradient from a first UE via a first resource of the first plurality of respective resources and receiving a second local gradient from a second UE via a second resource of the first plurality of respective resources, wherein the first resource is different than the second resource.

In a third additional aspect, alone or in combination with one or more of the first and second aspects, transmitting the combined gradient includes transmitting a waveform that includes an indication of the combined gradient, wherein the waveform has a form that is common for communications between the network node and a plurality of reporting UEs that includes the reporting UE and the at least one other reporting UE.

In a fourth additional aspect, alone or in combination with one or more of the first through third aspects, the waveform is an analog waveform that indicates a magnitude of the combined gradient and at least one other combined gradient.

In a fifth additional aspect, alone or in combination with one or more of the first through fourth aspects, receiving the plurality of local gradients includes receiving digital feedback that indicates the plurality of local gradients, and transmitting the combined gradient includes transmitting analog feedback that indicates the combined gradient.

In a sixth additional aspect, alone or in combination with one or more of the first through fifth aspects, generating the combined gradient includes computing the median of the plurality of local gradients or computing the trimmed average of the plurality of local gradients.

In a seventh additional aspect, alone or in combination with one or more of the first through sixth aspects, process 1100 includes receiving, from the network node, configuration information that includes one or more parameters for computing the trimmed average of the plurality of local gradients.

In an eighth additional aspect, alone or in combination with one or more of the first through seventh aspects, the plurality of respective transmitter UEs are associated with a group of transmitter UEs that is selected by the network node.

In a ninth additional aspect, alone or in combination with one or more of the first through eighth aspects, the reporting UE is at least one of a trusted reporting UE or an authenticated reporting UE.

In a tenth additional aspect, alone or in combination with one or more of the first through ninth aspects, the reporting UE is randomly selected from a plurality of trusted reporting UEs or a plurality of authenticated reporting UEs.

In an eleventh additional aspect, alone or in combination with one or more of the first through tenth aspects, receiving the plurality of local gradients includes receiving the plurality of local gradients via a sidelink interface.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, by a reporting UE that supports gradient communication for model updating in accordance with the present disclosure. Example process 1200 is an example where the reporting UE (for example, UE 120 or reporting UE 805) performs operations associated with gradient communication for model updating.

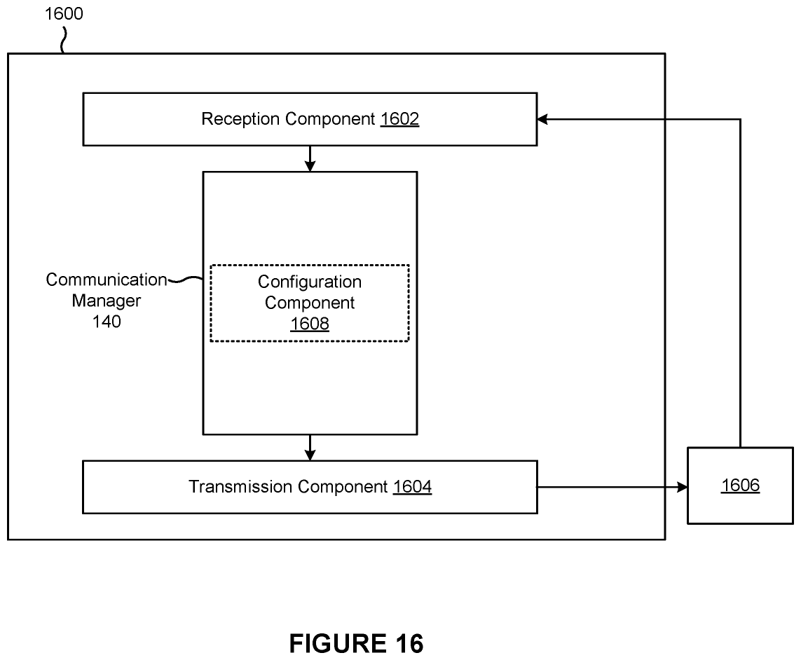

As shown in FIG. 12, in some aspects, process 1200 may include receiving feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource (block 1210). For example, the reporting UE (such as by using communication manager 140 or reception component 1602, depicted in FIG. 16) may receive feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource, as described above.

As further shown in FIG. 12, in some aspects, process 1200 may include transmitting the aggregate gradient to a network node via a second resource, of a plurality of second resources, that is configured for communicating the aggregate gradient between the reporting UE and the network node, where each second resource of the plurality of second resources is configured for communicating an aggregate gradient between a respective reporting UE and the network node (block 1220). For example, the reporting UE (such as by using communication manager 140 or transmission component 1604, depicted in FIG. 16) may transmit the aggregate gradient to a network node via a second resource that is configured for communicating the aggregate gradient between the reporting UE and the network node, as described above.

Process 1200 may include additional aspects, such as any single aspect or any combination of aspects described below or in connection with one or more other processes described elsewhere herein.

In a first additional aspect, receiving the feedback includes receiving a waveform that includes an indication of the aggregate gradient, wherein the waveform has a form that is common for communications between the network node and a plurality of reporting UEs that includes the reporting UE and at least one other reporting UE.

In a second additional aspect, alone or in combination with the first aspect, transmitting the aggregate gradient to the network node via the second resource includes transmitting one or more bits that include an indication of the aggregate gradient to the network node via the second resource.

In a third additional aspect, alone or in combination with one or more of the first and second aspects, receiving the feedback includes receiving analog feedback that indicates the aggregate gradient, and transmitting the aggregate gradient includes transmitting digital feedback that indicates the aggregate gradient.

In a fourth additional aspect, alone or in combination with one or more of the first through third aspects, process 1200 includes receiving configuration information from the network node that includes information associated with the first resource.

In a fifth additional aspect, alone or in combination with one or more of the first through fourth aspects, the plurality of transmitter UEs are associated with a group of transmitter UEs that is selected by the network node.

In a sixth additional aspect, alone or in combination with one or more of the first through fifth aspects, the reporting UE is at least one of a trusted reporting UE or an authenticated reporting UE.

In a seventh additional aspect, alone or in combination with one or more of the first through sixth aspects, the reporting UE is randomly selected from a plurality of trusted reporting UEs or a plurality of authenticated reporting UEs.

In an eighth additional aspect, alone or in combination with one or more of the first through seventh aspects, receiving the feedback includes receiving the feedback via a sidelink interface.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a flowchart illustrating an example process 1300 performed, for example, by a network node that supports gradient communication for model updating in accordance with the present disclosure. Example process 1300 is an example where the network node (for example, network node 110) performs operations associated with gradient communication for model updating.

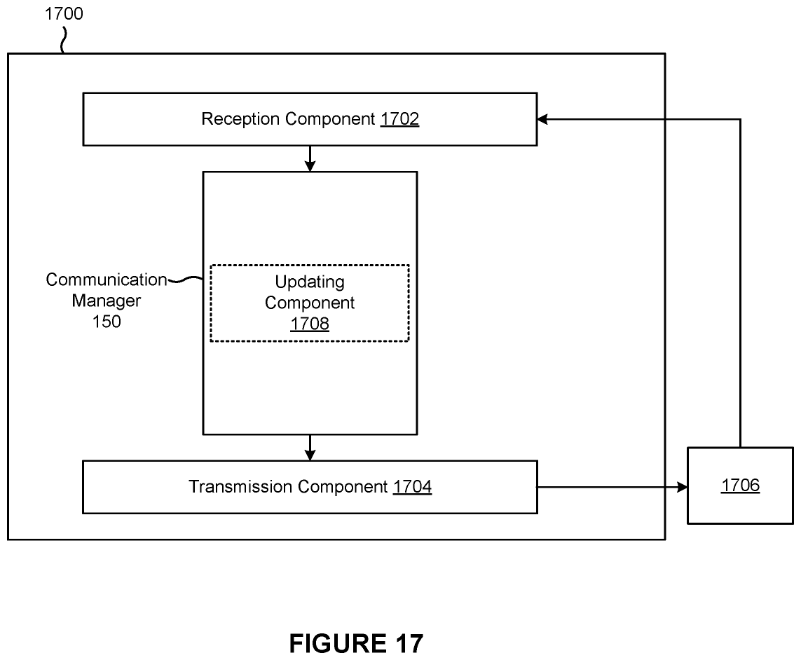

As shown in FIG. 13, in some aspects, process 1300 may include transmitting, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs (block 1310). For example, the network node (such as by using communication manager 150 or transmission component 1704, depicted in FIG. 17) may transmit, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs, as described above.

As further shown in FIG. 13, in some aspects, process 1300 may include receiving a plurality of combined gradients from the plurality of reporting UEs based on the one or more parameters, wherein the plurality of combined gradients are received via a second resource that is shared by the plurality of reporting UEs (block 1320). For example, the network node (such as by using communication manager 150 or reception component 1702, depicted in FIG. 17) may receive a plurality of combined gradients from the plurality of reporting UEs based on the one or more parameters, wherein the plurality of combined gradients are received via a second resource that is shared by the plurality of reporting UEs, as described above.

As further shown in FIG. 13, in some aspects, process 1300 may include updating a model based at least in part on the plurality of combined gradients (block 1330). For example, the network node (such as by using communication manager 150 or updating component 1708, depicted in FIG. 17) may update a model based at least in part on the plurality of combined gradients, as described above.

Process 1300 may include additional aspects, such as any single aspect or any combination of aspects described below or in connection with one or more other processes described elsewhere herein.

In a first additional aspect, each combined gradient of the plurality of combined gradients is a median gradient that is based at least in part on the respective plurality of local gradients or a trimmed average gradient that is based at least in part on the respective plurality of local gradients.

In a second additional aspect, alone or in combination with the first aspect, the one or more parameters indicate a percentage value for generating the trimmed average gradient.

In a third additional aspect, alone or in combination with one or more of the first and second aspects, receiving the plurality of combined gradients includes receiving the plurality of combined gradients via an interface that is shared by the reporting UE and at least one other reporting UE for communicating with the network node.

In a fourth additional aspect, alone or in combination with one or more of the first through third aspects, the interface is configured for transmitting an analog waveform that is shared by the reporting UE and the at least one other reporting UE for communicating with the network node.

In a fifth additional aspect, alone or in combination with one or more of the first through fourth aspects, process 1300 includes transmitting group information for grouping the plurality of reporting UEs and a plurality of transmitter UEs.

In a sixth additional aspect, alone or in combination with one or more of the first through fifth aspects, the group information indicates for the reporting UE to transmit the plurality of combined gradients that are associated with a plurality of respective transmitter UEs that are within a same group as the reporting UE.

In a seventh additional aspect, alone or in combination with one or more of the first through sixth aspects, the reporting UE is selected from a plurality of trusted reporting UEs or a plurality of authenticated reporting UEs, and the group information indicates a random selection of the reporting UE for transmitting a combined gradient of the plurality of combined gradients.

Although FIG. 13 shows example blocks of process 1300, in some aspects, process 1300 may include additional blocks, fewer blocks, different blocks, or differently arranged blocks than those depicted in FIG. 13. Additionally or alternatively, two or more of the blocks of process 1300 may be performed in parallel.

FIG. 14 is a flowchart illustrating an example process 1400 performed, for example, by a network node that supports gradient communication for model updating in accordance with the present disclosure. Example process 1400 is an example where the network node (for example, network node 110) performs operations associated with gradient communication for model updating.

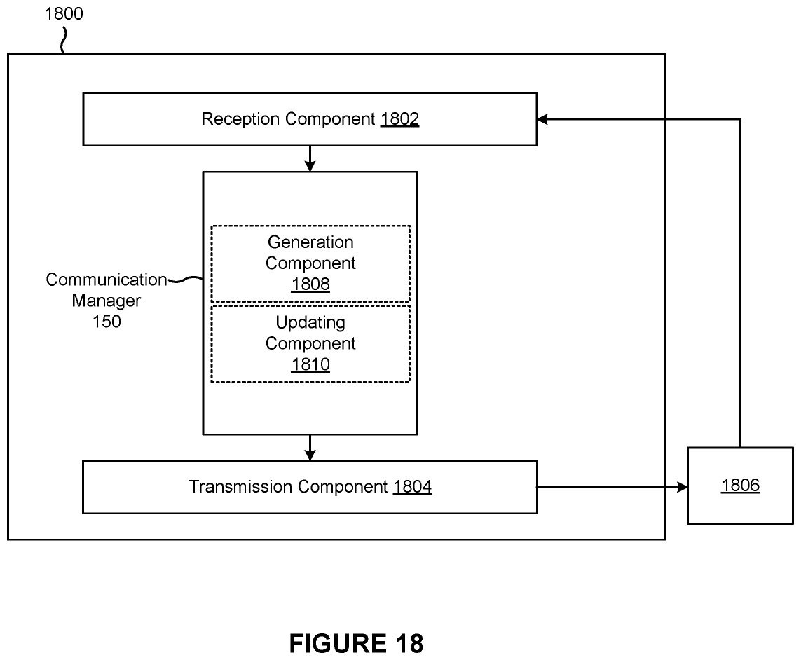

As shown in FIG. 14, in some aspects, process 1400 may include transmitting, to a plurality of reporting UEs, configuration information that indicates a plurality of resources, wherein each resource of the plurality of resources is configured for a respective reporting UE of the plurality of reporting UEs for communicating an aggregate gradient to the network node (block 1410). For example, the network node (such as by using communication manager 150 or transmission component 1804, depicted in FIG. 18) may transmit, to a plurality of reporting UEs, configuration information that indicates a plurality of resources, wherein each resource of the plurality of resources is configured for a respective reporting UE of the plurality of reporting UEs for communicating an aggregate gradient to the network node, as described above.

As further shown in FIG. 14, in some aspects, process 1400 may include receiving one or more aggregate gradients, wherein each aggregate gradient of the one or more aggregate gradients is received from a respective reporting UE of the plurality of reporting UEs via a respective resource of the plurality of resources that is configured for the respective reporting UE (block 1420). For example, the network node (such as by using communication manager 150 or reception component 1802, depicted in FIG. 18) may receive one or more aggregate gradients, wherein each aggregate gradient of the one or more aggregate gradients is received from a respective reporting UE of the plurality of reporting UEs via a respective resource of the plurality of resources that is configured for the respective reporting UE, as described above.

As further shown in FIG. 14, in some aspects, process 1400 may include generating a combined gradient based at least in part on a median of the one or more aggregate gradients or a trimmed average of the one or more aggregate gradients (block 1430). For example, the network node (such as by using communication manager 150 or generation component 1808, depicted in FIG. 18) may generate a combined gradient based at least in part on a median of the one or more aggregate gradients or a trimmed average of the one or more aggregate gradients, as described above.

As further shown in FIG. 14, in some aspects, process 1400 may include updating a model based at least in part on the combined gradient (block 1440). For example, the network node (such as by using communication manager 150 or updating component 1810, depicted in FIG. 18) may update a model based at least in part on the combined gradient, as described above.

Process 1400 may include additional aspects, such as any single aspect or any combination of aspects described below or in connection with one or more other processes described elsewhere herein.

In a first additional aspect, generating the combined gradient includes computing the median of the one or more aggregate gradients or computing the trimmed average of the one or more aggregate gradients.

In a second additional aspect, alone or in combination with the first aspect, receiving the one or more aggregate gradients includes receiving a first aggregate gradient from a first reporting UE of the plurality of reporting UEs via a first resource of the plurality of resources and receiving a second aggregate gradient from a second reporting UE of the plurality of reporting UEs via a second resource of the plurality of resources, wherein the first resource is different than the second resource.

In a third additional aspect, alone or in combination with one or more of the first and second aspects, process 1400 includes transmitting group information for grouping the plurality of reporting UEs and a plurality of transmitter UEs.

In a fourth additional aspect, alone or in combination with one or more of the first through third aspects, the group information indicates for a select reporting UE of the plurality of reporting UEs to transmit a combined gradient that is associated with a plurality of transmitter UEs that are within a same group as the select reporting UE.

In a fifth additional aspect, alone or in combination with one or more of the first through fourth aspects, the select reporting UE is selected from a plurality of trusted reporting UEs or a plurality of authenticated reporting UEs, and the group information indicates a random selection of the select reporting UE for transmitting the combined gradient.

Although FIG. 14 shows example blocks of process 1400, in some aspects, process 1400 may include additional blocks, fewer blocks, different blocks, or differently arranged blocks than those depicted in FIG. 14. Additionally or alternatively, two or more of the blocks of process 1400 may be performed in parallel.

FIG. 15 is a diagram of an example apparatus 1500 for wireless communication that supports gradient communication for model updating in accordance with the present disclosure. The apparatus 1500 may be a reporting UE, or a reporting UE may include the apparatus 1500. In some aspects, the apparatus 1500 includes a reception component 1502, a transmission component 1504, and a communication manager 140, which may be in communication with one another (for example, via one or more buses). As shown, the apparatus 1500 may communicate with another apparatus 1506 (such as a UE, a network node, or another wireless communication device) using the reception component 1502 and the transmission component 1504.

In some aspects, the apparatus 1500 may be configured to perform one or more operations described herein in connection with FIGS. 9-10. Additionally or alternatively, the apparatus 1500 may be configured to perform one or more processes described herein, such as process 1100 of FIG. 11. In some aspects, the apparatus 1500 may include one or more components of the UE described above in connection with FIG. 2.

The reception component 1502 may receive communications, such as reference signals, control information, data communications, or a combination thereof, from the apparatus 1506. The reception component 1502 may provide received communications to one or more other components of the apparatus 1500, such as the communication manager 140. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1502 may include one or more antennas, a modem, a demodulator, a MIMO detector, a receive processor, a controller/processor, a memory, or a combination thereof, of the reporting UE described above in connection with FIG. 2.

The transmission component 1504 may transmit communications, such as reference signals, control information, data communications, or a combination thereof, to the apparatus 1506. In some aspects, the communication manager 140 may generate communications and may transmit the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the reporting UE described above in connection with FIG. 2. In some aspects, the transmission component 1504 may be co-located with the reception component 1502 in a transceiver.

The communication manager 140 may receive or may cause the reception component 1502 to receive feedback that indicates a plurality of local gradients from a plurality of respective transmitter UEs via a first plurality of respective resources. The communication manager 140 may generate a combined gradient based at least in part on a median of the plurality of local gradients or a trimmed average of the plurality of local gradients. The communication manager 140 may transmit or may cause the transmission component 1504 to transmit the combined gradient to a network node via a second resource that is shared by the reporting UE and at least one other reporting UE configured to transmit a respective combined gradient to the network node. In some aspects, the communication manager 140 may perform one or more operations described elsewhere herein as being performed by one or more components of the communication manager 140.

The communication manager 140 may include a controller/processor, a memory, or a combination thereof, of the reporting UE described above in connection with FIG. 2. In some aspects, the communication manager 140 includes a set of components, such as a generation component 1508. Alternatively, the set of components may be separate and distinct from the communication manager 140. In some aspects, one or more components of the set of components may include or may be implemented within a controller/processor, a memory, or a combination thereof, of the reporting UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive feedback that indicates a plurality of local gradients from a plurality of respective transmitter UEs via a first plurality of respective resources. The generation component 1508 may generate a combined gradient based at least in part on a median of the plurality of local gradients or a trimmed average of the plurality of local gradients. The transmission component 1504 may transmit the combined gradient to a network node via a second resource that is shared by the reporting UE and at least one other reporting UE configured to transmit a respective combined gradient to the network node. The reception component 1502 may receive, from the network node, configuration information that includes one or more parameters for computing the trimmed average of the plurality of local gradients.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally or alternatively, a set of (one or more) components shown in FIG. 15 may perform one or more functions described as being performed by another set of components shown in FIG. 15.

FIG. 16 is a diagram of an example apparatus 1600 for wireless communication that supports gradient communication for model updating in accordance with the present disclosure. The apparatus 1600 may be a reporting UE, or a reporting UE may include the apparatus 1600. In some aspects, the apparatus 1600 includes a reception component 1602, a transmission component 1604, and a communication manager 140, which may be in communication with one another (for example, via one or more buses). As shown, the apparatus 1600 may communicate with another apparatus 1606 (such as a UE, a network node, or another wireless communication device) using the reception component 1602 and the transmission component 1604.

In some aspects, the apparatus 1600 may be configured to perform one or more operations described herein in connection with FIGS. 9-10. Additionally or alternatively, the apparatus 1600 may be configured to perform one or more processes described herein, such as process 1200 of FIG. 12. In some aspects, the apparatus 1600 may include one or more components of the UE described above in connection with FIG. 2.

The reception component 1602 may receive communications, such as reference signals, control information, data communications, or a combination thereof, from the apparatus 1606. The reception component 1602 may provide received communications to one or more other components of the apparatus 1600, such as the communication manager 140. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1602 may include one or more antennas, a modem, a demodulator, a MIMO detector, a receive processor, a controller/processor, a memory, or a combination thereof, of the reporting UE described above in connection with FIG. 2.

The transmission component 1604 may transmit communications, such as reference signals, control information, data communications, or a combination thereof, to the apparatus 1606. In some aspects, the communication manager 140 may generate communications and may transmit the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the reporting UE described above in connection with FIG. 2. In some aspects, the transmission component 1604 may be co-located with the reception component 1602 in a transceiver.

The communication manager 140 may receive or may cause the reception component 1602 to receive feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource. The communication manager 140 may transmit or may cause the transmission component 1604 to transmit the aggregate gradient to a network node via a second resource, of a plurality of second resources, that is configured for communicating the aggregate gradient between the reporting UE and the network node, where each second resource of the plurality of second resources is configured for communicating an aggregate gradient between a respective reporting UE and the network node. In some aspects, the communication manager 140 may perform one or more operations described elsewhere herein as being performed by one or more components of the communication manager 140.

The communication manager 140 may include a controller/processor, a memory, or a combination thereof, of the reporting UE described above in connection with FIG. 2. In some aspects, the communication manager 140 includes a set of components, such as a configuration component 1608. Alternatively, the set of components may be separate and distinct from the communication manager 140. In some aspects, one or more components of the set of components may include or may be implemented within a controller/processor, a memory, or a combination thereof, of the reporting UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource. The transmission component 1604 may transmit the aggregate gradient to a network node via a second resource, of a plurality of second resources, that is configured for communicating the aggregate gradient between the reporting UE and the network node, where each second resource of the plurality of second resources is configured for communicating an aggregate gradient between a respective reporting UE and the network node. The reception component 1602 may receive configuration information from the network node that includes information associated with the first resource. The configuration component 1608 or the reception component 1602 may receive configuration information that includes information associated with the first resource or the second resource.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally or alternatively, a set of (one or more) components shown in FIG. 16 may perform one or more functions described as being performed by another set of components shown in FIG. 16.

FIG. 17 is a diagram of an example apparatus 1700 for wireless communication that supports gradient communication for model updating in accordance with the present disclosure. The apparatus 1700 may be a network node, or a network node may include the apparatus 1700. In some aspects, the apparatus 1700 includes a reception component 1702, a transmission component 1704, and a communication manager 150, which may be in communication with one another (for example, via one or more buses). As shown, the apparatus 1700 may communicate with another apparatus 1706 (such as a UE, a network node, or another wireless communication device) using the reception component 1702 and the transmission component 1704.

In some aspects, the apparatus 1700 may be configured to perform one or more operations described herein in connection with FIGS. 9-10. Additionally or alternatively, the apparatus 1700 may be configured to perform one or more processes described herein, such as process 1300 of FIG. 131n some aspects, the apparatus 1700 may include one or more components of the network node described above in connection with FIG. 2.

The reception component 1702 may receive communications, such as reference signals, control information, data communications, or a combination thereof, from the apparatus 1706. The reception component 1702 may provide received communications to one or more other components of the apparatus 1700, such as the communication manager 150. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1702 may include one or more antennas, a modem, a demodulator, a MIMO detector, a receive processor, a controller/processor, a memory, or a combination thereof, of the network node described above in connection with FIG. 2.

The transmission component 1704 may transmit communications, such as reference signals, control information, data communications, or a combination thereof, to the apparatus 1706. In some aspects, the communication manager 150 may generate communications and may transmit the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network node described above in connection with FIG. 2. In some aspects, the transmission component 1704 may be co-located with the reception component 1702 in a transceiver.

The communication manager 150 may transmit or may cause the transmission component 1704 to transmit, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs. The communication manager 150 may receive or may cause the reception component 1702 to receive a plurality of combined gradients from the plurality of reporting UEs based on the one or more parameters, wherein the plurality of combined gradients are received via a second resource that is shared by the plurality of reporting UEs. The communication manager 150 may update a model based at least in part on the plurality of combined gradients. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the network node described above in connection with FIG. 2. In some aspects, the communication manager 150 includes a set of components, such as an updating component 1708. Alternatively, the set of components may be separate and distinct from the communication manager 150. In some aspects, one or more components of the set of components may include or may be implemented within a controller/processor, a memory, a scheduler, a communication unit, or a combination thereof, of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1704 may transmit, to a plurality of reporting UEs, configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs. The reception component 1702 may receive a plurality of combined gradients from the plurality of reporting UEs based on the one or more parameters, wherein the plurality of combined gradients are received via a second resource that is shared by the plurality of reporting UEs. The updating component 1708 may update a model based at least in part on the plurality of combined gradients. The transmission component 1704 may transmit group information for grouping the plurality of reporting UEs and a plurality of transmitter UEs.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally or alternatively, a set of (one or more) components shown in FIG. 17 may perform one or more functions described as being performed by another set of components shown in FIG. 17.

FIG. 18 is a diagram of an example apparatus 1800 for wireless communication that supports gradient communication for model updating in accordance with the present disclosure. The apparatus 1800 may be a network node, or a network node may include the apparatus 1800. In some aspects, the apparatus 1800 includes a reception component 1802, a transmission component 1804, and a communication manager 150, which may be in communication with one another (for example, via one or more buses). As shown, the apparatus 1800 may communicate with another apparatus 1806 (such as a UE, a network node, or another wireless communication device) using the reception component 1802 and the transmission component 1804.

In some aspects, the apparatus 1800 may be configured to perform one or more operations described herein in connection with FIGS. 9-10. Additionally or alternatively, the apparatus 1800 may be configured to perform one or more processes described herein, such as process 1400 of FIG. 14. In some aspects, the apparatus 1800 may include one or more components of the network node described above in connection with FIG. 2.

The reception component 1802 may receive communications, such as reference signals, control information, data communications, or a combination thereof, from the apparatus 1806. The reception component 1802 may provide received communications to one or more other components of the apparatus 1800, such as the communication manager 150. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1802 may include one or more antennas, a modem, a demodulator, a MIMO detector, a receive processor, a controller/processor, a memory, or a combination thereof, of the network node described above in connection with FIG. 2.

The transmission component 1804 may transmit communications, such as reference signals, control information, data communications, or a combination thereof, to the apparatus 1806. In some aspects, the communication manager 150 may generate communications and may transmit the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the network node described above in connection with FIG. 2. In some aspects, the transmission component 1804 may be co-located with the reception component 1802 in a transceiver.

The communication manager 150 may transmit or may cause the transmission component 1804 to transmit, to a plurality of reporting UEs, configuration information that indicates a plurality of resources, wherein each resource of the plurality of resources is configured for a respective reporting UE of the plurality of reporting UEs for communicating an aggregate gradient to the network node. The communication manager 150 may receive or may cause the reception component 1802 to receive one or more aggregate gradients, wherein each aggregate gradient of the one or more aggregate gradients is received from a respective reporting UE of the plurality of reporting UEs via a respective resource of the plurality of resources that is configured for the respective reporting UE. The communication manager 150 may generate a combined gradient based at least in part on a median of the one or more aggregate gradients or a trimmed average of the one or more aggregate gradients. The communication manager 150 may update a model based at least in part on the combined gradient. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the network node described above in connection with FIG. 2. In some aspects, the communication manager 150 includes a set of components, such as a generation component 1808, an updating component 1810, or a combination thereof. Alternatively, the set of components may be separate and distinct from the communication manager 150. In some aspects, one or more components of the set of components may include or may be implemented within a controller/processor, a memory, a scheduler, a communication unit, or a combination thereof, of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1804 may transmit, to a plurality of reporting UEs, configuration information that indicates a plurality of resources, wherein each resource of the plurality of resources is configured for a respective reporting UE of the plurality of reporting UEs for communicating an aggregate gradient to the network node. The reception component 1802 may receive one or more aggregate gradients, wherein each aggregate gradient of the one or more aggregate gradients is received from a respective reporting UE of the plurality of reporting UEs via a respective resource of the plurality of resources that is configured for the respective reporting UE. The generation component 1808 may generate a combined gradient based at least in part on a median of the one or more aggregate gradients or a trimmed average of the one or more aggregate gradients. The updating component 1810 may update a model based at least in part on the combined gradient.

The transmission component 1804 may transmit group information for grouping the plurality of reporting UEs and a plurality of transmitter UEs.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally or alternatively, a set of (one or more) components shown in FIG. 18 may perform one or more functions described as being performed by another set of components shown in FIG. 18.

The following provides an overview of some Aspects of the present disclosure:

Aspect 1: A method of wireless communication performed by a reporting user equipment (UE), comprising: receiving feedback that indicates a plurality of local gradients from a plurality of respective transmitter UEs via a first plurality of respective resources; generating a combined gradient based at least in part on a median of the plurality of local gradients or a trimmed average of the plurality of local gradients; and transmitting the combined gradient to a network node via a second resource that is shared by the reporting UE and at least one other reporting UE configured to transmit a respective combined gradient to the network node.

Aspect 2: The method of Aspect 1, wherein each local gradient of the plurality of local gradients is encoded into one or more bits, wherein the one or more bits are associated with a select resource of the first plurality of respective resources.

Aspect 3: The method of any of Aspects 1-2, wherein receiving the plurality of local gradients from the plurality of respective transmitter UEs via the first plurality of respective resources comprises receiving a first local gradient from a first UE via a first resource of the first plurality of respective resources and receiving a second local gradient from a second UE via a second resource of the first plurality of respective resources, wherein the first resource is different than the second resource.

Aspect 4: The method of any of Aspects 1-3, wherein transmitting the combined gradient comprises transmitting a waveform that includes an indication of the combined gradient, wherein the waveform has a form that is common for communications between the network node and a plurality of reporting UEs that includes the reporting UE and the at least one other reporting UE.

Aspect 5: The method of Aspect 4, wherein the waveform is an analog waveform that indicates a magnitude of the combined gradient and at least one other combined gradient.

Aspect 6: The method of any of Aspects 1-5, wherein receiving the plurality of local gradients comprises receiving digital feedback that indicates the plurality of local gradients, and wherein transmitting the combined gradient comprises transmitting analog feedback that indicates the combined gradient.

Aspect 7: The method of any of Aspects 1-6, wherein generating the combined gradient comprises computing the median of the plurality of local gradients or computing the trimmed average of the plurality of local gradients.

Aspect 8: The method of any of Aspects 1-7, further comprising receiving, from the network node, configuration information that includes one or more parameters for computing the trimmed average of the plurality of local gradients.

Aspect 9: The method of any of Aspects 1-8, wherein the plurality of respective transmitter UEs are associated with a group of transmitter UEs that is selected by the network node.

Aspect 10: The method of any of Aspects 1-9, wherein the reporting UE is at least one of a trusted reporting UE or an authenticated reporting UE.

Aspect 11: The method of Aspect 10, wherein the reporting UE is randomly selected from a plurality of trusted reporting UEs or a plurality of authenticated reporting UEs.

Aspect 12: The method of any of Aspects 1-11, wherein receiving the plurality of local gradients comprises receiving the plurality of local gradients via a sidelink interface.

Aspect 13: A method of wireless communication performed by a reporting user equipment (UE), comprising: receiving feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource; and transmitting the aggregate gradient to a network node via a second resource, of a plurality of second resources, that is configured for communicating the aggregate gradient between the reporting UE and the network node, wherein each second resource of the plurality of second resources is configured for communicating an aggregate gradient between a respective reporting UE and the network node.

Aspect 14: The method of Aspect 13, wherein receiving the feedback comprises receiving a waveform that includes an indication of the aggregate gradient, wherein the waveform has a form that is common for communications between the network node and a plurality of reporting UEs that includes the reporting UE and at least one other reporting UE.

Aspect 15: The method of any of Aspects 13-14, wherein transmitting the aggregate gradient to the network node via the second resource comprises transmitting one or more bits that include an indication of the aggregate gradient to the network node via the second resource.

Aspect 16: The method of any of Aspects 13-15, wherein receiving the feedback comprises receiving analog feedback that indicates the aggregate gradient, and wherein transmitting the aggregate gradient comprises transmitting digital feedback that indicates the aggregate gradient.

Aspect 17: The method of any of Aspects 13-16, further comprising receiving configuration information from the network node that includes information associated with the first resource.

Aspect 18: The method of any of Aspects 13-17, wherein the plurality of transmitter UEs are associated with a group of transmitter UEs that is selected by the network node.

Aspect 19: The method of any of Aspects 13-18, wherein the reporting UE is at least one of a trusted reporting UE or an authenticated reporting UE.

Aspect 20: The method of Aspect 19, wherein the reporting UE is randomly selected from a plurality of trusted reporting UEs or a plurality of authenticated reporting UEs.

Aspect 21: The method of any of Aspects 13-20, wherein receiving the feedback comprises receiving the feedback via a sidelink interface.

Aspect 22: A method of wireless communication performed by a network node, comprising: transmitting, to a plurality of reporting user equipments (UEs), configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs; receiving a plurality of combined gradients from the plurality of reporting UEs based on the one or more parameters, wherein the plurality of combined gradients are received via a second resource that is shared by the plurality of reporting UEs; and updating a model based at least in part on the plurality of combined gradients.

Aspect 23: The method of Aspect 22, wherein each combined gradient of the plurality of combined gradients is a median gradient that is based at least in part on the respective plurality of local gradients or a trimmed average gradient that is based at least in part on the respective plurality of local gradients.

Aspect 24: The method of Aspect 23, wherein the one or more parameters indicate a percentage value for generating the trimmed average gradient.

Aspect 25: The method of any of Aspects 22-24, wherein receiving the plurality of combined gradients comprises receiving the plurality of combined gradients via an interface that is shared by the reporting UE and at least one other reporting UE for communicating with the network node.

Aspect 26: The method of Aspect 25, wherein the interface is configured for transmitting an analog waveform that is shared by the reporting UE and the at least one other reporting UE for communicating with the network node.

Aspect 27: The method of any of Aspects 22-26, further comprising transmitting group information for grouping the plurality of reporting UEs and a plurality of transmitter UEs.

Aspect 28: The method of Aspect 27, wherein the group information indicates for the reporting UE to transmit the plurality of combined gradients that are associated with a plurality of respective transmitter UEs that are within a same group as the reporting UE.

Aspect 29: The method of Aspect 28, wherein the reporting UE is selected from a plurality of trusted reporting UEs or a plurality of authenticated reporting UEs, and wherein the group information indicates a random selection of the reporting UE for transmitting a combined gradient of the plurality of combined gradients.

Aspect 30: A method of wireless communication performed by a network node, comprising: transmitting, to a plurality of reporting user equipments (UEs), configuration information that indicates a plurality of resources, wherein each resource of the plurality of resources is configured for a respective reporting UE of the plurality of reporting UEs for communicating an aggregate gradient to the network node; receiving one or more aggregate gradients, wherein each aggregate gradient of the one or more aggregate gradients is received from a respective reporting UE of the plurality of reporting UEs via a respective resource of the plurality of resources that is configured for the respective reporting UE; generating a combined gradient based at least in part on a median of the one or more aggregate gradients or a trimmed average of the one or more aggregate gradients; and updating a model based at least in part on the combined gradient.

Aspect 31: The method of Aspect 30, wherein generating the combined gradient comprises computing the median of the one or more aggregate gradients or computing the trimmed average of the one or more aggregate gradients.

Aspect 32: The method of any of Aspects 30-31, wherein receiving the one or more aggregate gradients comprises receiving a first aggregate gradient from a first reporting UE of the plurality of reporting UEs via a first resource of the plurality of resources and receiving a second aggregate gradient from a second reporting UE of the plurality of reporting UEs via a second resource of the plurality of resources, wherein the first resource is different than the second resource.

Aspect 33: The method of any of Aspects 30-32, further comprising transmitting group information for grouping the plurality of reporting UEs and a plurality of transmitter UEs.

Aspect 34: The method of Aspect 33, wherein the group information indicates for a select reporting UE of the plurality of reporting UEs to transmit a combined gradient that is associated with a plurality of transmitter UEs that are within a same group as the select reporting UE.

Aspect 35: The method of Aspect 34, wherein the select reporting UE is selected from a plurality of trusted reporting UEs or a plurality of authenticated reporting UEs, and wherein the group information indicates a random selection of the select reporting UE for transmitting the combined gradient.

Aspect 36: An apparatus for wireless communication at a device, comprising a processor; memory coupled with the processor; and instructions stored in the memory and executable by the processor to cause the apparatus to perform the method of one or more of Aspects 1-12.

Aspect 37: A device for wireless communication, comprising a memory and one or more processors coupled to the memory, the one or more processors configured to perform the method of one or more of Aspects 1-12.

Aspect 38: An apparatus for wireless communication, comprising at least one means for performing the method of one or more of Aspects 1-12.

Aspect 39: A non-transitory computer-readable medium storing code for wireless communication, the code comprising instructions executable by a processor to perform the method of one or more of Aspects 1-12.

Aspect 40: A non-transitory computer-readable medium storing a set of instructions for wireless communication, the set of instructions comprising one or more instructions that, when executed by one or more processors of a device, cause the device to perform the method of one or more of Aspects 1-12.

Aspect 41: An apparatus for wireless communication at a device, comprising a processor; memory coupled with the processor; and instructions stored in the memory and executable by the processor to cause the apparatus to perform the method of one or more of Aspects 13-21.

Aspect 42: A device for wireless communication, comprising a memory and one or more processors coupled to the memory, the one or more processors configured to perform the method of one or more of Aspects 13-21.

Aspect 43: An apparatus for wireless communication, comprising at least one means for performing the method of one or more of Aspects 13-21.

Aspect 44: A non-transitory computer-readable medium storing code for wireless communication, the code comprising instructions executable by a processor to perform the method of one or more of Aspects 13-21.

Aspect 45: A non-transitory computer-readable medium storing a set of instructions for wireless communication, the set of instructions comprising one or more instructions that, when executed by one or more processors of a device, cause the device to perform the method of one or more of Aspects 13-21.

Aspect 46: An apparatus for wireless communication at a device, comprising a processor; memory coupled with the processor; and instructions stored in the memory and executable by the processor to cause the apparatus to perform the method of one or more of Aspects 22-29.

Aspect 47: A device for wireless communication, comprising a memory and one or more processors coupled to the memory, the one or more processors configured to perform the method of one or more of Aspects 22-29.

Aspect 48: An apparatus for wireless communication, comprising at least one means for performing the method of one or more of Aspects 22-29.

Aspect 49: A non-transitory computer-readable medium storing code for wireless communication, the code comprising instructions executable by a processor to perform the method of one or more of Aspects 22-29.

Aspect 50: A non-transitory computer-readable medium storing a set of instructions for wireless communication, the set of instructions comprising one or more instructions that, when executed by one or more processors of a device, cause the device to perform the method of one or more of Aspects 22-29.

Aspect 51: An apparatus for wireless communication at a device, comprising a processor; memory coupled with the processor; and instructions stored in the memory and executable by the processor to cause the apparatus to perform the method of one or more of Aspects 30-35.

Aspect 52: A device for wireless communication, comprising a memory and one or more processors coupled to the memory, the one or more processors configured to perform the method of one or more of Aspects 30-35.

Aspect 53: An apparatus for wireless communication, comprising at least one means for performing the method of one or more of Aspects 30-35.

Aspect 54: A non-transitory computer-readable medium storing code for wireless communication, the code comprising instructions executable by a processor to perform the method of one or more of Aspects 30-35.

Aspect 55: A non-transitory computer-readable medium storing a set of instructions for wireless communication, the set of instructions comprising one or more instructions that, when executed by one or more processors of a device, cause the device to perform the method of one or more of Aspects 30-35.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A reporting user equipment (UE) for wireless communication, comprising:
at least one memory; and
at least one processor communicatively coupled with the at least one memory, the at least one processor configured to cause the UE to:
receive feedback that indicates a plurality of local gradients from a plurality of respective transmitter UEs via a first plurality of respective resources;
generate a combined gradient based at least in part on a median of the plurality of local gradients or a trimmed average of the plurality of local gradients; and
transmit the combined gradient to a network node via a second resource that is shared by the reporting UE and at least one other reporting UE configured to transmit a respective combined gradient to the network node.

2. The UE of claim 1, wherein each local gradient of the plurality of local gradients is encoded into one or more bits, wherein the one or more bits are associated with a select resource of the first plurality of respective resources.

3. The UE of claim 1, wherein, to cause the UE to receive the plurality of local gradients from the plurality of respective transmitter UEs via the first plurality of respective resources, the at least one processor is configured to cause the UE to receive a first local gradient from a first UE via a first resource of the first plurality of respective resources and receiving a second local gradient from a second UE via a second resource of the first plurality of respective resources, wherein the first resource is different than the second resource.

4. The UE of claim 1, wherein, to cause the UE to transmit the combined gradient, the at least one processor is configured to cause the UE to transmit a waveform that includes an indication of the combined gradient, wherein the waveform has a form that is common for communications between the network node and a plurality of reporting UEs that includes the reporting UE and the at least one other reporting UE.

5. The UE of claim 4, wherein the waveform is an analog waveform that indicates a magnitude of the combined gradient and at least one other combined gradient.

6. The UE of claim 1, wherein, to cause the UE to receive the plurality of local gradients, the at least one processor is configured to cause the UE to receive digital feedback that indicates the plurality of local gradients, and wherein, to cause the UE to transmit the combined gradient, the at least one processor is configured to cause the UE to transmit analog feedback that indicates the combined gradient.

7. The UE of claim 1, wherein, to cause the UE to generate the combined gradient, the at least one processor is configured to cause the UE to compute the median of the plurality of local gradients or computing the trimmed average of the plurality of local gradients.

8. The UE of claim 1, wherein the at least one processor is configured to cause the UE to receive, from the network node, configuration information that includes one or more parameters for computing the trimmed average of the plurality of local gradients.

9. The UE of claim 1, wherein the plurality of respective transmitter UEs are associated with a group of transmitter UEs that is selected by the network node.

10. The UE of claim 1, wherein the reporting UE is at least one of a trusted reporting UE or an authenticated reporting UE.

11. The UE of claim 10, wherein the reporting UE is randomly selected from a plurality of trusted reporting UEs or a plurality of authenticated reporting UEs.

12. A reporting user equipment (UE) for wireless communication, comprising:
at least one memory; and
at least one processor communicatively coupled with the at least one memory, the at least one processor configured to cause the UE to:
receive feedback that indicates an aggregate gradient via a first resource that is shared by a plurality of transmitter UEs, wherein the aggregate gradient is an aggregate of a plurality of local gradients that are respectively transmitted by the plurality of transmitter UEs via the first resource; and
transmit the aggregate gradient to a network node via a second resource, of a plurality of second resources, that is configured for communicating the aggregate gradient between the reporting UE and the network node, wherein each second resource of the plurality of second resources is configured for communicating an aggregate gradient between a respective reporting UE and the network node.

13. The UE of claim 12, wherein, to cause the UE to receive the feedback, the at least one processor is configured to cause the UE to receive a waveform that includes an indication of the aggregate gradient, wherein the waveform has a form that is common for communications between the network node and a plurality of reporting UEs that includes the reporting UE and at least one other reporting UE.

14. The UE of claim 12, wherein, to cause the UE to transmit the aggregate gradient to the network node via the second resource, the at least one processor is configured to cause the UE to transmit one or more bits that include an indication of the aggregate gradient to the network node via the second resource.

15. The UE of claim 12, wherein, to cause the UE to receive the feedback, the at least one processor is configured to cause the UE to receive analog feedback that indicates the aggregate gradient, and wherein, to cause the UE to transmit the aggregate gradient, the at least one processor is configured to cause the UE to transmit digital feedback that indicates the aggregate gradient.

16. The UE of claim 12, wherein the at least one processor is configured to cause the UE to receive configuration information from the network node that includes information associated with the first resource.

17. The UE of claim 12, wherein the plurality of transmitter UEs are associated with a group of transmitter UEs that is selected by the network node.

18. The UE of claim 12, wherein the reporting UE is at least one of a trusted reporting UE or an authenticated reporting UE.

19. The UE of claim 18, wherein the reporting UE is randomly selected from a plurality of trusted reporting UEs or a plurality of authenticated reporting UEs.

20. A network node for wireless communication, comprising:
at least one memory; and
at least one processor communicatively coupled with the at least one memory, the at least one processor configured to cause the network node to:
transmit, to a plurality of reporting user equipments (UEs), configuration information that includes one or more parameters for generating a combined gradient that is based at least in part on a respective plurality of local gradients associated with respective reporting UEs of the plurality of reporting UEs, wherein the configuration information is transmitted via a first plurality of respective resources associated with respective reporting UEs of the plurality of reporting UEs;
receive a plurality of combined gradients from the plurality of reporting UEs based on the one or more parameters, wherein the plurality of combined gradients are received via a second resource that is shared by the plurality of reporting UEs; and
update a model based at least in part on the plurality of combined gradients.

21. The network node of claim 20, wherein each combined gradient of the plurality of combined gradients is a median gradient that is based at least in part on the respective plurality of local gradients or a trimmed average gradient that is based at least in part on the respective plurality of local gradients.

22. The network node of claim 21, wherein the one or more parameters indicate a percentage value for generating the trimmed average gradient.

23. The network node of claim 20, wherein, to cause the network node to receive the plurality of combined gradients, the at least one processor is configured to cause the network node to receive the plurality of combined gradients via an interface that is shared by the reporting UE and at least one other reporting UE for communicating with the network node.

24. The network node of claim 23, wherein the interface is configured for transmitting an analog waveform that is shared by the reporting UE and the at least one other reporting UE for communicating with the network node.

25. The network node of claim 20, wherein the at least one processor is configured to cause the network node to transmit group information for grouping the plurality of reporting UEs and a plurality of transmitter UEs.

26. The network node of claim 25, wherein the group information indicates for the reporting UE to transmit the plurality of combined gradients that are associated with a plurality of respective transmitter UEs that are within a same group as the reporting UE.

27. A network node for wireless communication, comprising:
at least one memory; and
at least one processor communicatively coupled with the at least one memory, the at least one processor configured to cause the network node to:
transmit, to a plurality of reporting user equipments (UEs), configuration information that indicates a plurality of resources, wherein each resource of the plurality of resources is configured for a respective reporting UE of the plurality of reporting UEs for communicating an aggregate gradient to the network node;
receive one or more aggregate gradients, wherein each aggregate gradient of the one or more aggregate gradients is received from a respective reporting UE of the plurality of reporting UEs via a respective resource of the plurality of resources that is configured for the respective reporting UE;
generate a combined gradient based at least in part on a median of the one or more aggregate gradients or a trimmed average of the one or more aggregate gradients; and
update a model based at least in part on the combined gradient.

28. The network node of claim 27, wherein, to cause the network node to generate the combined gradient, the at least one processor is configured to cause the network node to compute the median of the one or more aggregate gradients or computing the trimmed average of the one or more aggregate gradients.

29. The network node of claim 27, wherein, to cause the network node to receive the one or more aggregate gradients, the at least one processor is configured to cause the network node to receive a first aggregate gradient from a first reporting UE of the plurality of reporting UEs via a first resource of the plurality of resources and receive a second aggregate gradient from a second reporting UE of the plurality of reporting UEs via a second resource of the plurality of resources, wherein the first resource is different than the second resource.

30. The network node of claim 27, wherein the at least one processor is configured to cause the network node to transmit group information for grouping the plurality of reporting UEs and a plurality of transmitter UEs.
